(19) United States
(12) Patent Application Publication
(10) Pub. No.: US 2025/0317602 A1
(43) Pub. Date: Oct. 9, 2025

(54) SCALABLE GENERATIVE VIDEO CODING

(71) Applicant: Alibaba (China) Co., Ltd., Hangzhou (CN)

(72) Inventors: Jie CHEN, Beijing (CN); Bolin CHEN, Kowloon Tong (HK); Yan YE, San Diego, CA (US)

(21) Appl. No.: 19/096,404

(22) Filed: Mar. 31, 2025

Related U.S. Application Data
(60) Provisional application No. 63/575,626, filed on Apr. 6, 2024.

(51) Int. Cl. H04N 19/70

(52) U.S. Cl. CPC H04N 19/70

(57) ABSTRACT

Methods are provided for scalable generative video coding. An exemplary video decoding method includes: receiving a bitstream; decoding a supplemental enhancement information (SEI) message that is associated with a picture from the bitstream; and generating the picture based on the SEI message.

### CROSS-REFERENCE TO RELATED APPLICATIONS

The disclosure claims the benefit of priority to U.S. Provisional Application No. 63/575,626, filed on Apr. 6, 2024, which is incorporated herein by reference in its entirety.

### TECHNICAL FIELD

The present disclosure generally relates to video processing, and more particularly, to syntax design for scalable generative video coding.

### BACKGROUND

A video is a set of static pictures (or “frames”) capturing the visual information. To reduce the storage memory and the transmission bandwidth, a video can be compressed before storage or transmission and decompressed before display. The compression process is usually referred to as encoding and the decompression process is usually referred to as decoding. There are various video coding formats which use standardized video coding technologies, most commonly based on prediction, transform, quantization, entropy coding and in-loop filtering. The video coding standards, such as the High Efficiency Video Coding (HEVC/H.265) standard, the Versatile Video Coding (VVC/H.266) standard, AVS standards, specifying the specific video coding formats, are developed by standardization organizations. With more and more advanced video coding technologies being adopted in the video standards, the coding efficiency of the new video coding standards get higher and higher.

### SUMMARY OF THE DISCLOSURE

The disclosed embodiments of the present disclosure provide methods for scalable generative video coding.

According to some exemplary embodiments, there is provided a video decoding method, including: receiving a bitstream; decoding a supplemental enhancement information (SEI) message that is associated with a picture from the bitstream; and generating the picture based on the SEI message.

According to some exemplary embodiments, there is provided a video encoding method, including: receiving a video sequence; and encoding features of a picture of the video sequence in a supplemental enhancement information (SEI) message.

According to some exemplary embodiments, there is provided a method of generating a bitstream, including: receiving a video sequence; encoding features of a picture of the video sequence in a supplemental enhancement information (SEI) message; and generating a bitstream associated with the SEI message.

According to some exemplary embodiments, there is provided a non-transitory computer readable storage medium storing a bitstream of a video. The bitstream includes features of a picture of a video sequence in a supplemental enhancement information (SEI) message.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a schematic diagram illustrating an exemplary system for coding image data, according to some embodiments of the present disclosure.

FIG. 2A is a schematic diagram illustrating an exemplary encoding process of a hybrid video coding system, consistent with embodiments of the disclosure.

FIG. 2B is a schematic diagram illustrating another exemplary encoding process of a hybrid video coding system, consistent with embodiments of the disclosure.

FIG. 3A is a schematic diagram illustrating an exemplary decoding process of a hybrid video coding system, consistent with embodiments of the disclosure.

FIG. 3B is a schematic diagram illustrating another exemplary decoding process of a hybrid video coding system, consistent with embodiments of the disclosure.

FIG. 4 is a block diagram of an exemplary apparatus for coding image data, according to some embodiments of the present disclosure.

FIG. 5 is a schematic diagram illustrating an architecture of a traditional video compression framework.

FIG. 6 is a schematic diagram illustrating an exemplary architecture of an end-to-end deep-based video compression framework, according to some embodiments of the present disclosure.

FIG. 7 is a schematic diagram illustrating another exemplary architecture of an end-to-end deep-based video generative compression framework, according to some embodiments of the present disclosure.

FIG. 8 is a schematic diagram illustrating an exemplary encoder-decoder coding framework with a 1×4×4 compact feature size for a talking face video, according to some embodiments of the present disclosure.

FIG. 9 is a schematic diagram illustrating an exemplary Pleno-Generation (PGen) framework based on scalable representation and layered reconstruction (SRLR) for bandwidth-intelligent face video communication, according to some embodiments of the present disclosure.

FIG. 10A is a flowchart of an exemplary video decoding method, according to some embodiments of the present disclosure.

FIG. 10B is flowchart illustrating sub-steps of the exemplary video decoding method shown in FIG. 10A, according to some embodiments of the present disclosure.

FIG. 10C is flowchart illustrating sub-steps of the exemplary video decoding method shown in FIG. 10A, according to some embodiments of the present disclosure.

FIG. 11 is a flowchart of an exemplary video encoding method, according to some embodiments of the present disclosure.

FIG. 12 is a flowchart illustrating sub-steps of the exemplary video encoding method shown in FIG. 11, according to some embodiments of the present disclosure.

FIG. 13 is a flowchart illustrating sub-steps of the exemplary video encoding method shown in FIG. 11, according to some embodiments of the present disclosure.

FIG. 14 is a flowchart of an exemplary video decoding method, according to some embodiments of the present disclosure.

FIG. 15 is flowchart illustrating sub-steps of the exemplary video decoding method shown in 14, according to some embodiments of the present disclosure.

FIG. 16 is flowchart illustrating sub-steps of the exemplary video decoding method shown in 14, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

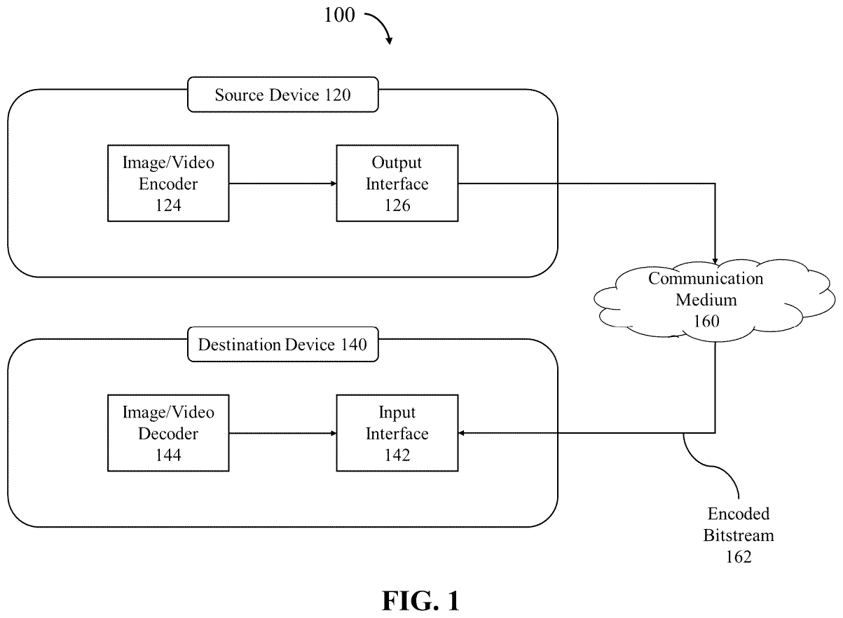

FIG. 1 is a block diagram illustrating a system 100 for coding image data, according to some disclosed embodiments. The image data may include an image (also called a “picture” or “frame”), multiple images, or a video. An image is a static picture. Multiple images may be related or unrelated, either spatially or temporary. A video is a set of images arranged in a temporal sequence.

As shown in FIG. 1, system 100 includes a source device 120 that provides encoded video data to be decoded at a later time by a destination device 140. Consistent with the disclosed embodiments, each of source device 120 and destination device 140 may include any of a wide range of devices, including a desktop computer, a notebook (e.g., laptop) computer, a server, a tablet computer, a set-top box, a mobile phone, a vehicle, a camera, an image sensor, a robot, a television, a camera, a wearable device (e.g., a smart watch or a wearable camera), a display device, a digital media player, a video gaming console, a video streaming device, or the like. Source device 120 and destination device 140 may be equipped for wireless or wired communication.

Referring to FIG. 1, source device 120 may include an image/video encoder 124 an output interface 126. Destination device 140 may include an input interface 142 and an image/video decoder 144. Image/video encoder 124 encodes the input bitstream and outputs an encoded bitstream 162 via output interface 126. Encoded bitstream 162 is transmitted through a communication medium 160, and received by input interface 142. Image/video decoder 144 then decodes encoded bitstream 162 to generate decoded data.

More specifically, source device 120 may further include various devices (not shown) for providing source image data to be processed by Image/video encoder 124. The devices for providing the source image data may include an image/video capture device, such as a camera, an image/video archive or storage device containing previously captured images/videos, or an image/video feed interface to receive images/videos from an image/video content provider.

Image/video encoder 124 and image/video decoder 144 each may be implemented as any of a variety of suitable encoder or decoder circuitry, such as one or more microprocessors, digital signal processors (DSPs), application specific integrated circuits (ASICs), field programmable gate arrays (FPGAs), discrete logic, software, hardware, firmware, or any combinations thereof. When the encoding or decoding is implemented partially in software, image/video encoder 124 or image/video decoder 144 may store instructions for the software in a suitable, non-transitory computer-readable medium and execute the instructions in hardware using one or more processors to perform the techniques consistent this disclosure. Each of image/video encoder 124 or image/video decoder 144 may be included in one or more encoders or decoders, either of which may be integrated as part of a combined encoder/decoder (CODEC) in a respective device.

Image/video encoder 124 and image/video decoder 144 may operate according to any video coding standard, such as Advanced Video Coding (AVC), High Efficiency Video Coding (HEVC), Versatile Video Coding (VVC), AOMedia Video 1 (AV1), Joint Photographic Experts Group (JPEG), Moving Picture Experts Group (MPEG), etc. Alternatively, image/video encoder 124 and image/video decoder 144 may be customized devices that do not comply with the existing standards. Although not shown in FIG. 1, in some embodiments, image/video encoder 124 and image/video decoder 144 may each be integrated with an audio encoder and decoder, and may include appropriate MUX-DEMUX units, or other hardware and software, to handle encoding of both audio and video in a common data stream or separate data streams.

Output interface 126 may include any type of medium or device capable of transmitting encoded bitstream 162 from source device 120 to destination device 140. For example, output interface 126 may include a transmitter or a transceiver configured to transmit encoded bitstream 162 from source device 120 directly to destination device 140 in real-time. Encoded bitstream 162 may be modulated according to a communication standard, such as a wireless communication protocol, and transmitted to destination device 140.

Communication medium 160 may include transient media, such as a wireless broadcast or wired network transmission. For example, communication medium 160 may include a radio frequency (RF) spectrum or one or more physical transmission lines (e.g., a cable). Communication medium 160 may form part of a packet-based network, such as a local area network, a wide-area network, or a global network such as the Internet. In some embodiments, communication medium 160 may include routers, switches, base stations, or any other equipment that may be useful to facilitate communication from source device 120 to destination device 140. For example, a network server (not shown) may receive encoded bitstream 162 from source device 120 and provide encoded bitstream 162 to destination device 140, e.g., via network transmission.

Communication medium 160 may also be in the form of a storage media (e.g., non-transitory storage media), such as a hard disk, flash drive, compact disc, digital video disc, Blu-ray disc, volatile or non-volatile memory, or any other suitable digital storage media for storing encoded image data. In some embodiments, a computing device of a medium production facility, such as a disc stamping facility, may receive encoded image data from source device 120 and produce a disc containing the encoded video data.

Input interface 142 may include any type of medium or device capable of receiving information from communication medium 160. The received information includes encoded bitstream 162. For example, input interface 142 may include a receiver or a transceiver configured to receive encoded bitstream 162 in real-time.

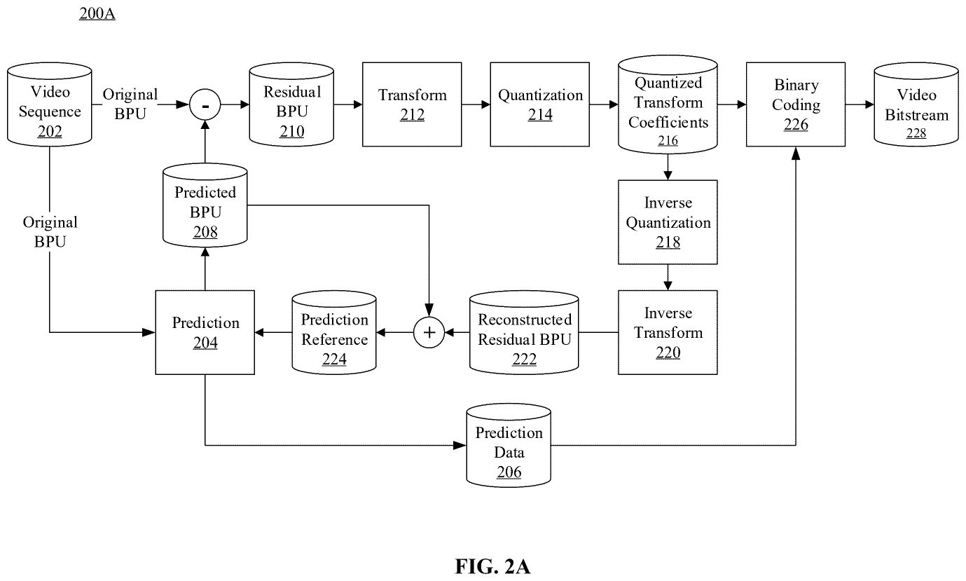

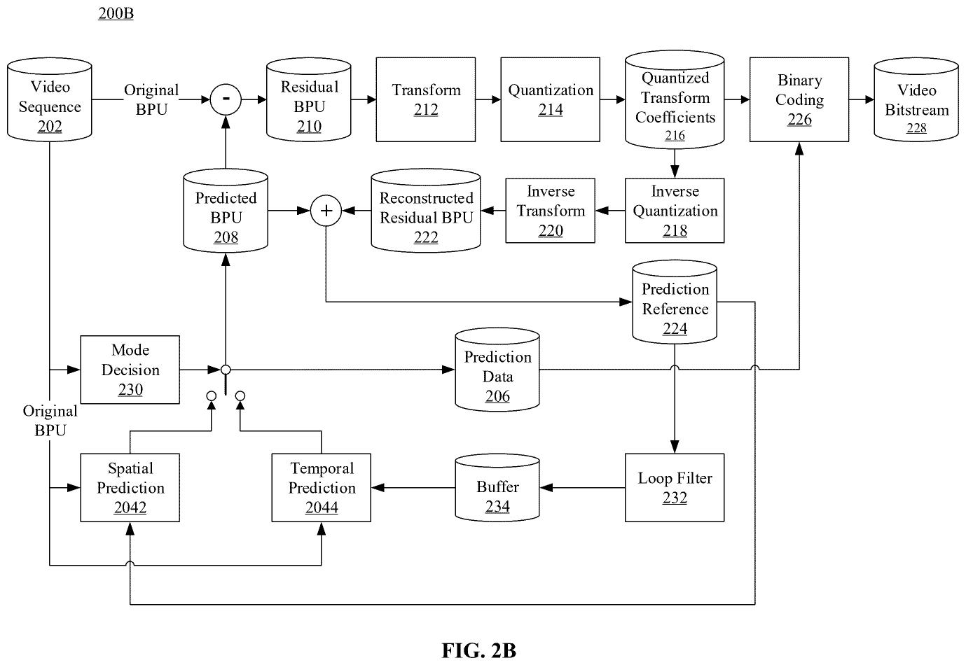

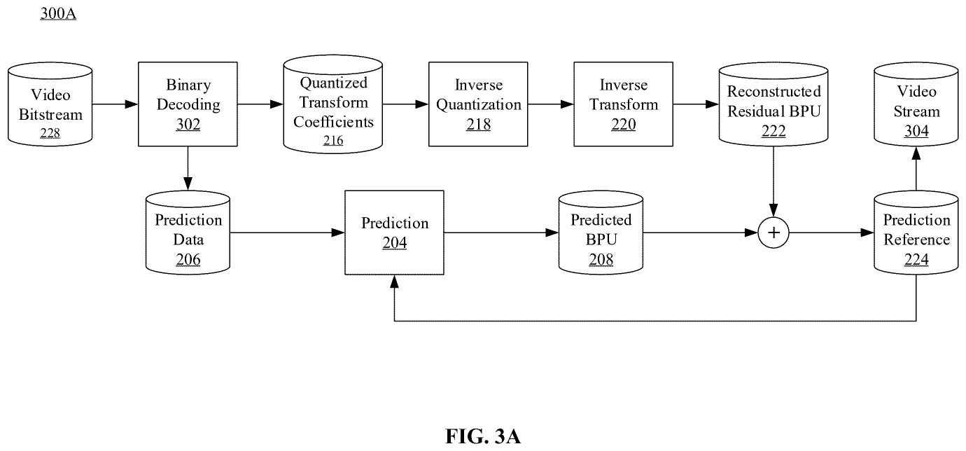

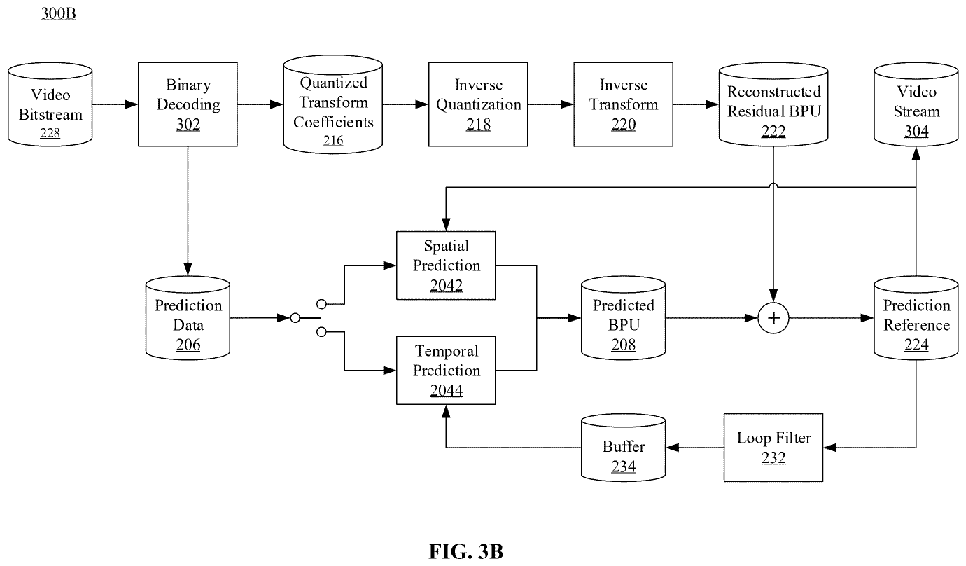

Next, exemplary image data encoding and decoding techniques (such as those utilized by image/video encoder 124 and image/video decoder 144) are described in connection with FIGS. 2A-2B and FIGS. 3A-3B.

FIG. 2A illustrates a schematic diagram of an example encoding process 200A, consistent with embodiments of the disclosure. For example, the encoding process 200A can be performed by an encoder, such as image/video encoder 124 in FIG. 1. As shown in FIG. 2A, the encoder can encode video sequence 202 into video bitstream 228 according to process 200A. Video sequence 202 can include a set of pictures (referred to as “original pictures”) arranged in a temporal order. Each original picture of video sequence 202 can be divided by the encoder into basic processing units, basic processing sub-units, or regions for processing. In some embodiments, the encoder can perform process 200A at the level of basic processing units for each original picture of video sequence 202. For example, the encoder can perform process 200A in an iterative manner, in which the encoder can encode a basic processing unit in one iteration of process 200A. In some embodiments, the encoder can perform process 200A in parallel for regions of each original picture of video sequence 202.

In FIG. 2A, the encoder can feed a basic processing unit (referred to as an “original BPU”) of an original picture of video sequence 202 to prediction stage 204 to generate prediction data 206 and predicted BPU 208. The encoder can subtract predicted BPU 208 from the original BPU to generate residual BPU 210. The encoder can feed residual BPU 210 to transform stage 212 and quantization stage 214 to generate quantized transform coefficients 216. The encoder can feed prediction data 206 and quantized transform coefficients 216 to binary coding stage 226 to generate video bitstream 228. Components 202, 204, 206, 208, 210, 212, 214, 216, 226, and 228 can be referred to as a “forward path.” During process 200A, after quantization stage 214, the encoder can feed quantized transform coefficients 216 to inverse quantization stage 218 and inverse transform stage 220 to generate reconstructed residual BPU 222. The encoder can add reconstructed residual BPU 222 to predicted BPU 208 to generate prediction reference 224, which is used in prediction stage 204 for the next iteration of process 200A. Components 218, 220, 222, and 224 of process 200A can be referred to as a “reconstruction path.” The reconstruction path can be used to ensure that both the encoder and the decoder use the same reference data for prediction.

The encoder can perform process 200A iteratively to encode each original BPU of the original picture (in the forward path) and generate predicted reference 224 for encoding the next original BPU of the original picture (in the reconstruction path). After encoding all original BPUs of the original picture, the encoder can proceed to encode the next picture in video sequence 202.

Referring to process 200A, the encoder can receive video sequence 202 generated by a video capturing device (e.g., a camera). The term “receive” used herein can refer to receiving, inputting, acquiring, retrieving, obtaining, reading, accessing, or any action in any manner for inputting data.

At prediction stage 204, at a current iteration, the encoder can receive an original BPU and prediction reference 224, and perform a prediction operation to generate prediction data 206 and predicted BPU 208. Prediction reference 224 can be generated from the reconstruction path of the previous iteration of process 200A. The purpose of prediction stage 204 is to reduce information redundancy by extracting prediction data 206 that can be used to reconstruct the original BPU as predicted BPU 208 from prediction data 206 and prediction reference 224.

Ideally, predicted BPU 208 can be identical to the original BPU. However, due to non-ideal prediction and reconstruction operations, predicted BPU 208 is generally slightly different from the original BPU. For recording such differences, after generating predicted BPU 208, the encoder can subtract it from the original BPU to generate residual BPU 210. For example, the encoder can subtract values (e.g., greyscale values or RGB values) of pixels of predicted BPU 208 from values of corresponding pixels of the original BPU. Each pixel of residual BPU 210 can have a residual value as a result of such subtraction between the corresponding pixels of the original BPU and predicted BPU 208. Compared with the original BPU, prediction data 206 and residual BPU 210 can have fewer bits, but they can be used to reconstruct the original BPU without significant quality deterioration. Thus, the original BPU is compressed.

To further compress residual BPU 210, at transform stage 212, the encoder can reduce spatial redundancy of residual BPU 210 by decomposing it into a set of two-dimensional “base patterns,” each base pattern being associated with a “transform coefficient.” The base patterns can have the same size (e.g., the size of residual BPU 210). Each base pattern can represent a variation frequency (e.g., frequency of brightness variation) component of residual BPU 210. None of the base patterns can be reproduced from any combinations (e.g., linear combinations) of any other base patterns. In other words, the decomposition can decompose variations of residual BPU 210 into a frequency domain. Such a decomposition is analogous to a discrete Fourier transform of a function, in which the base patterns are analogous to the base functions (e.g., trigonometry functions) of the discrete Fourier transform, and the transform coefficients are analogous to the coefficients associated with the base functions.

Different transform algorithms can use different base patterns. Various transform algorithms can be used at transform stage 212, such as, for example, a discrete cosine transform, a discrete sine transform, or the like. The transform at transform stage 212 is invertible. That is, the encoder can restore residual BPU 210 by an inverse operation of the transform (referred to as an “inverse transform”). For example, to restore a pixel of residual BPU 210, the inverse transform can be multiplying values of corresponding pixels of the base patterns by respective associated coefficients and adding the products to produce a weighted sum. For a video coding standard, both the encoder and decoder can use the same transform algorithm (thus the same base patterns). Thus, the encoder can record only the transform coefficients, from which the decoder can reconstruct residual BPU 210 without receiving the base patterns from the encoder. Compared with residual BPU 210, the transform coefficients can have fewer bits, but they can be used to reconstruct residual BPU 210 without significant quality deterioration. Thus, residual BPU 210 is further compressed.

The encoder can further compress the transform coefficients at quantization stage 214. In the transform process, different base patterns can represent different variation frequencies (e.g., brightness variation frequencies). Because human eyes are generally better at recognizing low-frequency variation, the encoder can disregard information of high-frequency variation without causing significant quality deterioration in decoding. For example, at quantization stage 214, the encoder can generate quantized transform coefficients 216 by dividing each transform coefficient by an integer value (referred to as a “quantization parameter”) and rounding the quotient to its nearest integer. After such an operation, some transform coefficients of the high-frequency base patterns can be converted to zero, and the transform coefficients of the low-frequency base patterns can be converted to smaller integers. The encoder can disregard the zero-value quantized transform coefficients 216, by which the transform coefficients are further compressed. The quantization process is also invertible, in which quantized transform coefficients 216 can be reconstructed to the transform coefficients in an inverse operation of the quantization (referred to as “inverse quantization”).

Because the encoder disregards the remainders of such divisions in the rounding operation, quantization stage 214 can be lossy. Typically, quantization stage 214 can contribute the most information loss in process 200A. The larger the information loss is, the fewer bits the quantized transform coefficients 216 can need. For obtaining different levels of information loss, the encoder can use different values of the quantization parameter or any other parameter of the quantization process.

At binary coding stage 226, the encoder can encode prediction data 206 and quantized transform coefficients 216 using a binary coding technique, such as, for example, entropy coding, variable length coding, arithmetic coding, Huffman coding, context-adaptive binary arithmetic coding, or any other lossless or lossy compression algorithm. In some embodiments, besides prediction data 206 and quantized transform coefficients 216, the encoder can encode other information at binary coding stage 226, such as, for example, a prediction mode used at prediction stage 204, parameters of the prediction operation, a transform type at transform stage 212, parameters of the quantization process (e.g., quantization parameters), an encoder control parameter (e.g., a bitrate control parameter), or the like. The encoder can use the output data of binary coding stage 226 to generate video bitstream 228. In some embodiments, video bitstream 228 can be further packetized for network transmission.

Referring to the reconstruction path of process 200A, at inverse quantization stage 218, the encoder can perform inverse quantization on quantized transform coefficients 216 to generate reconstructed transform coefficients. At inverse transform stage 220, the encoder can generate reconstructed residual BPU 222 based on the reconstructed transform coefficients. The encoder can add reconstructed residual BPU 222 to predicted BPU 208 to generate prediction reference 224 that is to be used in the next iteration of process 200A.

It should be noted that other variations of the process 200A can be used to encode video sequence 202. In some embodiments, stages of process 200A can be performed by the encoder in different orders. In some embodiments, one or more stages of process 200A can be combined into a single stage. In some embodiments, a single stage of process 200A can be divided into multiple stages. For example, transform stage 212 and quantization stage 214 can be combined into a single stage. In some embodiments, process 200A can include additional stages. In some embodiments, process 200A can omit one or more stages in FIG. 2A.

FIG. 2B illustrates a schematic diagram of another example encoding process 200B, consistent with embodiments of the disclosure. Process 200B can be modified from process 200A. For example, process 200B can be used by an encoder conforming to a hybrid video coding standard (e.g., H.26x series). Compared with process 200A, the forward path of process 200B additionally includes mode decision stage 230 and divides prediction stage 204 into spatial prediction stage 2042 and temporal prediction stage 2044. The reconstruction path of process 200B additionally includes loop filter stage 232 and buffer 234.

Generally, prediction techniques can be categorized into two types: spatial prediction and temporal prediction. Spatial prediction (e.g., an intra-picture prediction or “intra prediction”) can use pixels from one or more already coded neighboring BPUs in the same picture to predict the current BPU. That is, prediction reference 224 in the spatial prediction can include the neighboring BPUs. The spatial prediction can reduce the inherent spatial redundancy of the picture. Temporal prediction (e.g., an inter-picture prediction or “inter prediction”) can use regions from one or more already coded pictures to predict the current BPU. That is, prediction reference 224 in the temporal prediction can include the coded pictures. The temporal prediction can reduce the inherent temporal redundancy of the pictures.

Referring to process 200B, in the forward path, the encoder performs the prediction operation at spatial prediction stage 2042 and temporal prediction stage 2044. For example, at spatial prediction stage 2042, the encoder can perform the intra prediction. For an original BPU of a picture being encoded, prediction reference 224 can include one or more neighboring BPUs that have been encoded (in the forward path) and reconstructed (in the reconstructed path) in the same picture. The encoder can generate predicted BPU 208 by extrapolating the neighboring BPUs. The extrapolation technique can include, for example, a linear extrapolation or interpolation, a polynomial extrapolation or interpolation, or the like. In some embodiments, the encoder can perform the extrapolation at the pixel level, such as by extrapolating values of corresponding pixels for each pixel of predicted BPU 208. The neighboring BPUs used for extrapolation can be located with respect to the original BPU from various directions, such as in a vertical direction (e.g., on top of the original BPU), a horizontal direction (e.g., to the left of the original BPU), a diagonal direction (e.g., to the down-left, down-right, up-left, or up-right of the original BPU), or any direction defined in the used video coding standard. For the intra prediction, prediction data 206 can include, for example, locations (e.g., coordinates) of the used neighboring BPUs, sizes of the used neighboring BPUs, parameters of the extrapolation, a direction of the used neighboring BPUs with respect to the original BPU, or the like.

For another example, at temporal prediction stage 2044, the encoder can perform the inter prediction. For an original BPU of a current picture, prediction reference 224 can include one or more pictures (referred to as “reference pictures”) that have been encoded (in the forward path) and reconstructed (in the reconstructed path). In some embodiments, a reference picture can be encoded and reconstructed BPU by BPU. For example, the encoder can add reconstructed residual BPU 222 to predicted BPU 208 to generate a reconstructed BPU. When all reconstructed BPUs of the same picture are generated, the encoder can generate a reconstructed picture as a reference picture. The encoder can perform an operation of “motion estimation” to search for a matching region in a scope (referred to as a “search window”) of the reference picture. The location of the search window in the reference picture can be determined based on the location of the original BPU in the current picture. For example, the search window can be centered at a location having the same coordinates in the reference picture as the original BPU in the current picture and can be extended out for a predetermined distance. When the encoder identifies (e.g., by using a pel-recursive algorithm, a block-matching algorithm, or the like) a region similar to the original BPU in the search window, the encoder can determine such a region as the matching region. The matching region can have different dimensions (e.g., being smaller than, equal to, larger than, or in a different shape) from the original BPU. Because the reference picture and the current picture are temporally separated in the timeline, it can be deemed that the matching region “moves” to the location of the original BPU as time goes by. The encoder can record the direction and distance of such a motion as a “motion vector.” When multiple reference pictures are used, the encoder can search for a matching region and determine its associated motion vector for each reference picture. In some embodiments, the encoder can assign weights to pixel values of the matching regions of respective matching reference pictures.

The motion estimation can be used to identify various types of motions, such as, for example, translations, rotations, zooming, or the like. For inter prediction, prediction data 206 can include, for example, locations (e.g., coordinates) of the matching region, the motion vectors associated with the matching region, the number of reference pictures, weights associated with the reference pictures, or the like.

For generating predicted BPU 208, the encoder can perform an operation of “motion compensation.” The motion compensation can be used to reconstruct predicted BPU 208 based on prediction data 206 (e.g., the motion vector) and prediction reference 224. For example, the encoder can move the matching region of the reference picture according to the motion vector, in which the encoder can predict the original BPU of the current picture. When multiple reference pictures are used, the encoder can move the matching regions of the reference pictures according to the respective motion vectors and average pixel values of the matching regions. In some embodiments, if the encoder has assigned weights to pixel values of the matching regions of respective matching reference pictures, the encoder can add a weighted sum of the pixel values of the moved matching regions.

In some embodiments, the inter prediction can be unidirectional or bidirectional. Unidirectional inter predictions can use one or more reference pictures in the same temporal direction with respect to the current picture. Unidirectional inter predictions use a reference picture that precedes the current picture. Bidirectional inter predictions can use one or more reference pictures at both temporal directions with respect to the current picture.

Still referring to the forward path of process 200B, after spatial prediction 2042 and temporal prediction stage 2044, at mode decision stage 230, the encoder can select a prediction mode (e.g., one of the intra prediction or the inter prediction) for the current iteration of process 200B. For example, the encoder can perform a rate-distortion optimization technique, in which the encoder can select a prediction mode to minimize a value of a cost function depending on a bit rate of a candidate prediction mode and distortion of the reconstructed reference picture under the candidate prediction mode. Depending on the selected prediction mode, the encoder can generate the corresponding predicted BPU 208 and predicted data 206.

In the reconstruction path of process 200B, if intra prediction mode has been selected in the forward path, after generating prediction reference 224 (e.g., the current BPU that has been encoded and reconstructed in the current picture), the encoder can directly feed prediction reference 224 to spatial prediction stage 2042 for later usage (e.g., for extrapolation of a next BPU of the current picture). If the inter prediction mode has been selected in the forward path, after generating prediction reference 224 (e.g., the current picture in which all BPUs have been encoded and reconstructed), the encoder can feed prediction reference 224 to loop filter stage 232, at which the encoder can apply a loop filter to prediction reference 224 to reduce or eliminate distortion (e.g., blocking artifacts) introduced by the inter prediction. The encoder can apply various loop filter techniques at loop filter stage 232, such as, for example, deblocking, sample adaptive offsets, adaptive loop filters, or the like. The loop-filtered reference picture can be stored in buffer 234 (or “decoded picture buffer”) for later use (e.g., to be used as an inter-prediction reference picture for a future picture of video sequence 202). The encoder can store one or more reference pictures in buffer 234 to be used at temporal prediction stage 2044. In some embodiments, the encoder can encode parameters of the loop filter (e.g., a loop filter strength) at binary coding stage 226, along with quantized transform coefficients 216, prediction data 206, and other information.

FIG. 3A illustrates a schematic diagram of an example decoding process 300A, consistent with embodiments of the disclosure. Process 300A can be a decompression process corresponding to the compression process 200A in FIG. 2A. In some embodiments, process 300A can be similar to the reconstruction path of process 200A. A decoder (e.g., image/video decoder 144 in FIG. 1) can decode video bitstream 228 into video stream 304 according to process 300A. Video stream 304 can be very similar to video sequence 202. However, due to the information loss in the compression and decompression process (e.g., quantization stage 214 in FIGS. 2A-2B), generally, video stream 304 is not identical to video sequence 202. Similar to processes 200A and 200B in FIGS. 2A-2B, the decoder can perform process 300A at the level of basic processing units (BPUs) for each picture encoded in video bitstream 228. For example, the decoder can perform process 300A in an iterative manner, in which the decoder can decode a basic processing unit in one iteration of process 300A. In some embodiments, the decoder can perform process 300A in parallel for regions of each picture encoded in video bitstream 228.

In FIG. 3A, the decoder can feed a portion of video bitstream 228 associated with a basic processing unit (referred to as an “encoded BPU”) of an encoded picture to binary decoding stage 302. At binary decoding stage 302, the decoder can decode the portion into prediction data 206 and quantized transform coefficients 216. The decoder can feed quantized transform coefficients 216 to inverse quantization stage 218 and inverse transform stage 220 to generate reconstructed residual BPU 222. The decoder can feed prediction data 206 to prediction stage 204 to generate predicted BPU 208. The decoder can add reconstructed residual BPU 222 to predicted BPU 208 to generate predicted reference 224. In some embodiments, predicted reference 224 can be stored in a buffer (e.g., a decoded picture buffer in a computer memory). The decoder can feed predicted reference 224 to prediction stage 204 for performing a prediction operation in the next iteration of process 300A.

The decoder can perform process 300A iteratively to decode each encoded BPU of the encoded picture and generate predicted reference 224 for encoding the next encoded BPU of the encoded picture. After decoding all encoded BPUs of the encoded picture, the decoder can output the picture to video stream 304 for display and proceed to decode the next encoded picture in video bitstream 228.

At binary decoding stage 302, the decoder can perform an inverse operation of the binary coding technique used by the encoder (e.g., entropy coding, variable length coding, arithmetic coding, Huffman coding, context-adaptive binary arithmetic coding, or any other lossless compression algorithm). In some embodiments, besides prediction data 206 and quantized transform coefficients 216, the decoder can decode other information at binary decoding stage 302, such as, for example, a prediction mode, parameters of the prediction operation, a transform type, parameters of the quantization process (e.g., quantization parameters), an encoder control parameter (e.g., a bitrate control parameter), or the like. In some embodiments, if video bitstream 228 is transmitted over a network in packets, the decoder can depacketize video bitstream 228 before feeding it to binary decoding stage 302.

FIG. 3B illustrates a schematic diagram of another example decoding process 300B, consistent with embodiments of the disclosure. Process 300B can be modified from process 300A. For example, process 300B can be used by a decoder conforming to a hybrid video coding standard (e.g., H.26x series). Compared with process 300A, process 300B additionally divides prediction stage 204 into spatial prediction stage 2042 and temporal prediction stage 2044, and additionally includes loop filter stage 232 and buffer 234.

In process 300B, for an encoded basic processing unit (referred to as a “current BPU”) of an encoded picture (referred to as a “current picture”) that is being decoded, prediction data 206 decoded from binary decoding stage 302 by the decoder can include various types of data, depending on what prediction mode was used to encode the current BPU by the encoder. For example, if intra prediction was used by the encoder to encode the current BPU, prediction data 206 can include a prediction mode indicator (e.g., a flag value) indicative of the intra prediction, parameters of the intra prediction operation, or the like. The parameters of the intra prediction operation can include, for example, locations (e.g., coordinates) of one or more neighboring BPUs used as a reference, sizes of the neighboring BPUs, parameters of extrapolation, a direction of the neighboring BPUs with respect to the original BPU, or the like. For another example, if inter prediction was used by the encoder to encode the current BPU, prediction data 206 can include a prediction mode indicator (e.g., a flag value) indicative of the inter prediction, parameters of the inter prediction operation, or the like. The parameters of the inter prediction operation can include, for example, the number of reference pictures associated with the current BPU, weights respectively associated with the reference pictures, locations (e.g., coordinates) of one or more matching regions in the respective reference pictures, one or more motion vectors respectively associated with the matching regions, or the like.

Based on the prediction mode indicator, the decoder can decide whether to perform a spatial prediction (e.g., the intra prediction) at spatial prediction stage 2042 or a temporal prediction (e.g., the inter prediction) at temporal prediction stage 2044. The details of performing such spatial prediction or temporal prediction are described in FIG. 2B and will not be repeated hereinafter. After performing such spatial prediction or temporal prediction, the decoder can generate predicted BPU 208. The decoder can add predicted BPU 208 and reconstructed residual BPU 222 to generate prediction reference 224, as described in FIG. 3A.

In process 300B, the decoder can feed predicted reference 224 to spatial prediction stage 2042 or temporal prediction stage 2044 for performing a prediction operation in the next iteration of process 300B. For example, if the current BPU is decoded using the intra prediction at spatial prediction stage 2042, after generating prediction reference 224 (e.g., the decoded current BPU), the decoder can directly feed prediction reference 224 to spatial prediction stage 2042 for later usage (e.g., for extrapolation of a next BPU of the current picture). If the current BPU is decoded using the inter prediction at temporal prediction stage 2044, after generating prediction reference 224 (e.g., a reference picture in which all BPUs have been decoded), the encoder can feed prediction reference 224 to loop filter stage 232 to reduce or eliminate distortion (e.g., blocking artifacts). The decoder can apply a loop filter to prediction reference 224, in a way as described in FIG. 2B. The loop-filtered reference picture can be stored in buffer 234 (e.g., a decoded picture buffer in a computer memory) for later use (e.g., to be used as an inter-prediction reference picture for a future encoded picture of video bitstream 228). The decoder can store one or more reference pictures in buffer 234 to be used at temporal prediction stage 2044. In some embodiments, when the prediction mode indicator of prediction data 206 indicates that inter prediction was used to encode the current BPU, prediction data can further include parameters of the loop filter (e.g., a loop filter strength).

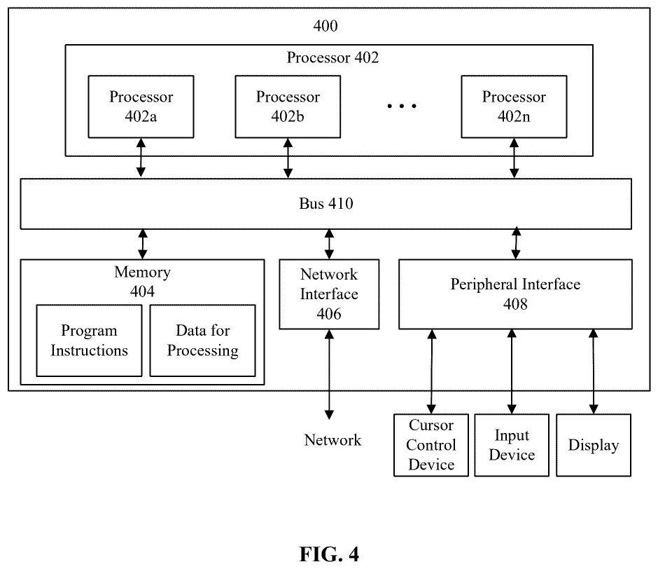

Referring back to FIG. 1, each image/video encoder 124 and image/video decoder 144 may be implemented as any suitable hardware, software, or a combination thereof. FIG. 4 is a block diagram of an example apparatus 400 for processing image data, consistent with embodiments of the disclosure. For example, apparatus 400 may be an encoder, or a decoder. As shown in FIG. 4, apparatus 400 can include processor 402. When processor 402 executes instructions described herein, apparatus 400 can become a specialized machine for encoding or decoding image data. Processor 402 can be any type of circuitry capable of manipulating or processing information. For example, processor 402 can include any combination of any number of a central processing unit (or “CPU”), a graphics processing unit (or “GPU”), a neural processing unit (“NPU”), a microcontroller unit (“MCU”), an optical processor, a programmable logic controller, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), or the like. In some embodiments, processor 402 can also be a set of processors grouped as a single logical component. For example, as shown in FIG. 4, processor 402 can include multiple processors, including processor 402a, processor 402b, and processor 402n.

Apparatus 400 can also include memory 404 configured to store data (e.g., a set of instructions, computer codes, intermediate data, or the like). For example, as shown in FIG. 4, the stored data can include program instructions (e.g., program instructions for implementing the stages in processes 200A, 200B, 300A, or 300B) and data for processing (e.g., video sequence 202, video bitstream 228, or video stream 304). Processor 402 can access the program instructions and data for processing (e.g., via bus 410), and execute the program instructions to perform an operation or manipulation on the data for processing. Memory 404 can include a high-speed random-access storage device or a non-volatile storage device. In some embodiments, memory 404 can include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or the like. Memory 404 can also be a group of memories (not shown in FIG. 4) grouped as a single logical component.

Bus 410 can be a communication device that transfers data between components inside apparatus 400, such as an internal bus (e.g., a CPU-memory bus), an external bus (e.g., a universal serial bus port, a peripheral component interconnect express port), or the like.

For ease of explanation without causing ambiguity, processor 402 and other data processing circuits are collectively referred to as a “data processing circuit” in this disclosure. The data processing circuit can be implemented entirely as hardware, or as a combination of software, hardware, or firmware. In addition, the data processing circuit can be a single independent module or can be combined entirely or partially into any other component of apparatus 400.

Apparatus 400 can further include network interface 406 to provide wired or wireless communication with a network (e.g., the Internet, an intranet, a local area network, a mobile communications network, or the like). In some embodiments, network interface 406 can include any combination of any number of a network interface controller (NIC), a radio frequency (RF) module, a transponder, a transceiver, a modem, a router, a gateway, a wired network adapter, a wireless network adapter, a Bluetooth adapter, an infrared adapter, a near-field communication (“NFC”) adapter, a cellular network chip, or the like.

In some embodiments, optionally, apparatus 400 can further include peripheral interface 408 to provide a connection to one or more peripheral devices. As shown in FIG. 4, the peripheral device can include, but is not limited to, a cursor control device (e.g., a mouse, a touchpad, or a touchscreen), a keyboard, a display (e.g., a cathode-ray tube display, a liquid crystal display, or a light-emitting diode display), a video input device (e.g., a camera or an input interface coupled to a video archive), or the like.

It should be noted that video codecs (e.g., a codec performing process 200A, 200B, 300A, or 300B) can be implemented as any combination of any software or hardware modules in apparatus 400. For example, some or all stages of process 200A, 200B, 300A, or 300B can be implemented as one or more software modules of apparatus 400, such as program instructions that can be loaded into memory 404. For another example, some or all stages of process 200A, 200B, 300A, or 300B can be implemented as one or more hardware modules of apparatus 400, such as a specialized data processing circuit (e.g., an FPGA, an ASIC, an NPU, or the like).

As described above, the traditional video compression standards, such as AVC, HEVC, and VVC, have been sophisticatedly developed to achieve excellent compression performance. In all these video coding standards, a block-based hybrid video coding framework is used to exploit the spatial redundancy, temporal redundancy and information entropy redundancy in video.

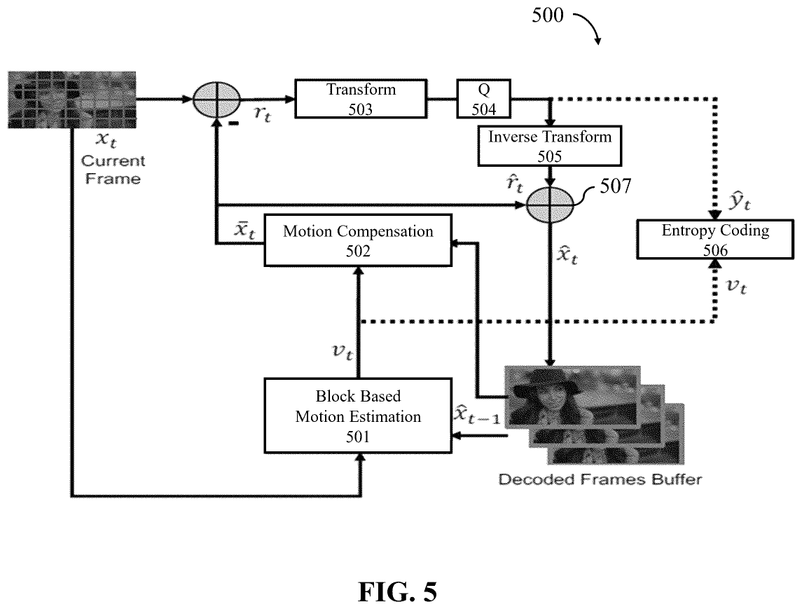

Generally, the video compression encoder generates the bitstream based on the input current frames. And the decoder reconstructs the video frames based on the received bitstreams. FIG. 5 is a schematic diagram illustrating an architecture of a traditional video compression framework, which illustrates a classic framework of video compression follows the predict-transform architecture.

Specifically, the input frame xₜ is split into a set of blocks, e.g., square regions, of the same size (e.g., 8×8). The encoding procedure of the traditional video compression algorithm in the encoder 500 side includes the following steps.

Motion estimation by block based motion estimation module 501 of the encoder 500: The motion estimation module 501 can estimate the motion between the current frame xₜ and the previous reconstructed frame \hat{x}ₜ₋₁. The corresponding motion vector vₜ for each block is obtained.

Motion compensation by motion compensation module 502 of the encoder 500: The predicted frame x̅ₜ is obtained by copying the corresponding pixels in the previous reconstructed frame to the current frame based on the motion vector vₜ determined by motion estimation module 501. Then, the residual rₜ between the original frame xₜ and the predicted frame x̅ₜ is obtained as rₜ=xₜ−x̅ₜ.

Transform and quantization by transform module 503 and Q module 504 of the encoder 500, respectively: The residual rₜ is quantized to ŷt by Q module 504. A linear transform (e.g., DCT) is used before quantization by transform module 503 for better compression performance.

Inverse transform by inverse transform module 505 of the encoder 500: The quantized result y̅ₜ is used by inverse transform for obtaining the reconstructed residual \hat{r}ₜ.

Entropy coding by entropy coding module 506 of the encoder 500: Both the motion vector vₜ and the quantized result y̅ₜ are encoded into bits by the entropy coding method and sent to the decoder.

Frame reconstruction by reconstruction module 507: The reconstructed frame rₜ is obtained by adding x̅ₜ and \hat{r}ₜ, i.e., x̅ₜ=r̅ₜ+x̅ₜ. The reconstructed frame will be used by the (t+1)ₜₕ frame for motion estimation.

For the decoder (not shown), based on the bits provided by entropy coding module 506 of the encoder 500, motion compensation, inverse quantization, and then frame reconstruction are performed to obtain the reconstructed frame x̅ₜ.

As described above, deep learning-based algorithms can be introduced to replace or enhance the traditional video coding tools, including intra/inter prediction, entropy coding and in-loop filtering. Regarding the joint optimization of the entire image/video compression framework rather than designing one particular module, end-to-end image/video compression algorithms can be used. For example, an end-to-end video coding scheme DVC scheme that jointly optimizes all the components for video compression can be used.

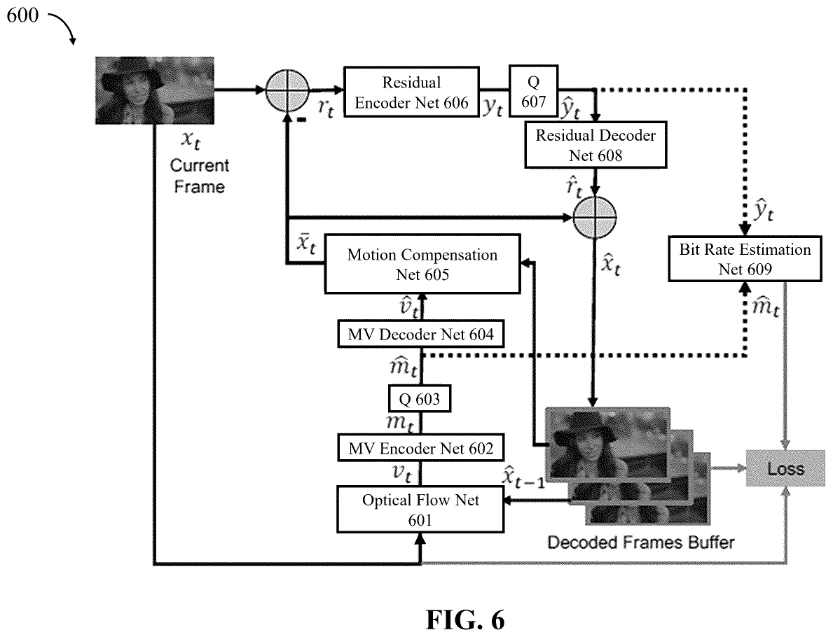

FIG. 6 is a schematic diagram illustrating an exemplary architecture of an end-to-end deep-based video compression framework, according to some embodiments of the present disclosure. FIG. 6 shows the basic framework of the first end-to-end video compression deep model that jointly optimizes all the components for video compression, such as motion estimation, motion compression, and residual compression. Specifically, learning based optical flow estimation is utilized to obtain the motion information and reconstruct the current frames. Then two auto-encoder style neural networks are employed to compress the corresponding motion and residual information. All the modules are jointly learned through a single loss function, in which they collaborate with each other by considering the trade-off between reducing the number of compression bits and improving quality of the decoded video. There is one-to-one correspondence between the traditional video compression framework shown in FIG. 5 and the novel end-to-end deep-based framework shown in FIG. 6. The relationship and brief summarization on the differences are introduced as follows. The procedure of encoder 600 may include the following steps.

Motion estimation and compression: In optical flow net module 601, a CNN (Convolutional Neural Network) model can be used to estimate the optical flow, which is considered as motion information vₜ. Instead of directly encoding the raw optical flow values, an MV encoder-decoder network to compress and decode the optical flow values. Firstly, MV encoder net module 602 can be used to encode the motion information vₜ. The encoded motion representation of motion information vₜ is mₜ, which can be further quantized, by Q module 603, as m̅ₜ. Then the corresponding reconstructed motion information \hat{v}t can be decoded by using MV decoder net module 604.

Motion compensation. A motion compensation network donated as motion compensation net module 605 is designed to obtain the predicted frame xₜ based on the optical flow obtained. Then, the residual rₜ between the original frame xₜ and the predicted frame xₜ is obtained as rₜ=xₜ−\hat{x}ₜ.

Transform, quantization and inverse transform: The linear transform is replaced by using a highly non-linear residual encoder-decoder network, such as the residual encoder net module 606 shown in FIG. 6, and the residual rₜ is non-linearly mapped to the representation yₜ. Then yₜ is quantized to yₜ by Q module 607. In order to build an end-to-end training scheme, the quantization method is used. The quantized representation ŷt is fed into the residual decoder network donated as residual decoder net module 608 to obtain the reconstructed residual \hat{r}ₜ.

Entropy coding: At the testing stage, the quantized motion representation \hat{m}ₜ and the residual representation ŷₜ are coded into bits by bit rate estimation net module 609 and sent to the decoder. At the training stage, to estimate the number of bits cost, the CNNs are used to obtain the probability distribution of each symbol in \hat{m}ₜ and ŷₜ.

Frame reconstruction (not shown): It is the same as the traditional method.

With the emergence of deep generative models including Variational Auto-Encoding (VAE) and Generative Adversarial Networks (GAN), the facial video compression can achieve promising performance improvement. For example, for video-to-video synthesis tasks, Face-vid2vid can be used. Moreover, schemes that leverage compact 3D keypoint representation to drive a generative model for rendering the target frame can also be used. Mobile-compatible video chat systems based on first order motion model (FOMM) can be used. VSBNet that utilizes the adversarial learning to reconstruct origin frames from the landmarks can also be used. In addition, an end-to-end talking-head video compression framework based upon compact feature learning (CFTE), designed for high efficiency talking face video compression towards ultra low bandwidth scenarios can be used. The CFTE scheme leverages the compact feature representation to compensate for the temporal evolution and reconstruct the target face video frame in an end-to-end manner. The CFTE scheme can be incorporated into the video coding framework with the supervision of rate-distortion objective.

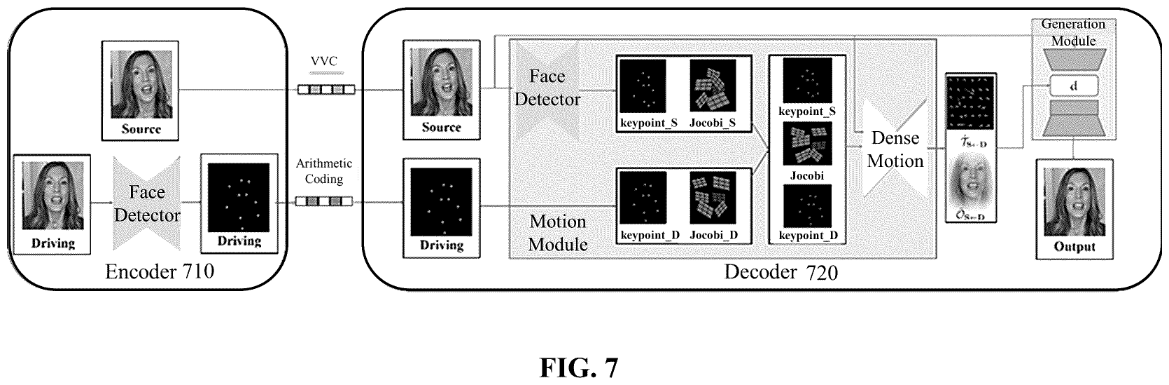

FIG. 7 is a schematic diagram illustrating another exemplary architecture of the deep-based video generative compression framework, according to some embodiments of the present disclosure. FIG. 7 gives the basic framework of the deep-based video generative compression scheme based First Order Motion Model (FOMM). The FOMM deforms a reference source frame to follow the motion of a driving video. While this method works on various types of videos (for example, Tai-chi, cartoons), this method is typically focused on face animation application. FOMM follows an encoder-decoder architecture with a motion transfer component including the following steps.

Firstly, a keypoint extractor (also referred to motion module of decoder 720) is learned using an equivariant loss, without explicit labels. By this keypoint extractor, two sets of ten learned keypoints are computed for the source and driving frames. The learned keypoints are transformed from the feature map with the size of channel×64×64 via the Gaussian map function, thus every corresponding keypoint can represent different channels-feature information. It should be mentioned that every keypoint is point of (x,y) that can represent the most important information of feature map.

Secondly, a dense motion network uses the landmarks and the source frame to produce a dense motion field and an occlusion map.

Then, the encoder 710 encodes the source frame via the traditional image/video compression method, such as HEVC/VVC or JPEG/BPG. Here, the VVC is used to compress the source frame.

In the later stage, the resulting feature map is warped using the dense motion field (using a differentiable grid-sample operation), then multiplied with the occlusion map.

Lastly, the decoder 720 generates an image from the warped map.

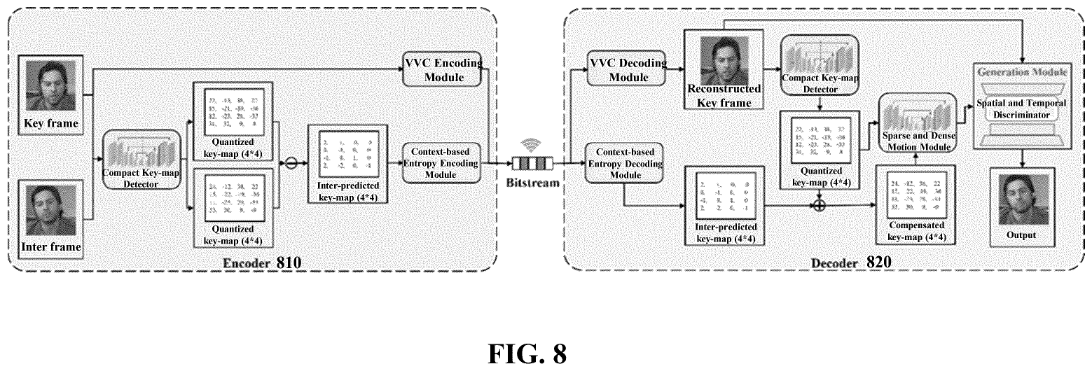

FIG. 8 is a schematic diagram illustrating an exemplary encoder-decoder coding framework with the 1×4×4 compact feature size for a talking face video, according to some embodiments of the present disclosure. FIG. 8 gives another basic framework of the deep-based video generative compression scheme based on compact feature representation, namely CFTE. It follows an encoder-decoder architecture that applies a context-based coding scheme.

At the encoder 810 side, the compression framework includes three modules: an encoder (e.g., VVC encoding module shown in FIG. 8) for compressing the key frame (also called base picture), a compact feature extractor (e.g., compact key-map detector shown in FIG. 8) for extracting the compact human features of the other inter frames, and a feature coding module (e.g., context-based entropy encoding module shown in FIG. 8) for compressing the inter-predicted residuals of compact human features to generate inter-predicted key-map as shown in FIG. 8. First, the key frame (also called base picture) that represents the human textures is compressed with the VVC encoder. Through the compact feature extractor, each of the subsequent inter frames is represented with a compact feature matrix with the size of 1×4×4. It should be mentioned that the size of compact feature matrix is not fixed and the number of feature parameters can also be increased or decreased according to the specific requirement of bit consumption. Then, these extracted features are inter-predicted and quantized, and the residuals are finally entropy-coded as the final bitstream.

At the decoder 820 side, this compression framework also contains three main modules, including a decoding module (e.g., VVC decoding module shown in FIG. 8) for reconstructing the key frame (also called base picture), a reconstruction module (e.g., context-based entropy decoding module shown in FIG. 8) for reconstructing the compact features by entropy decoding and compensation, and a generation module (e.g., generation module shown in FIG. 8) for generating the final video by leveraging the reconstructed features and decoded key frame (also called base picture). More specifically, during the generation of the final video, the decoded key frame (also called base picture) from the VVC bitstream can be further represented in the form of features through compact feature extraction. Subsequently, given the features from the key and inter frames, relevant sparse motion field is calculated, facilitating the generation of the pixel-wise dense motion map and occlusion map. Finally, based on deep generative model, the decoded key frame (also called base picture), pixel-wise dense motion map and occlusion map with implicit motion field characterization are used to produce the final video with accurate appearance, pose, and expression.

Table 1 shows some exemplary facial representations for generative face video compression (GFVC) algorithms and their corresponding interpretations. In particular, the face images may exhibit strong statistical regularities, which can be economically characterized with 2D landmarks, 2D keypoints, region matrix, 3D keypoints, compact feature matrix or facial semantics. Such facial description strategies can lead to reduced coding bit-rate and improve the coding efficiency, thus being applicable to video conferencing and live entertainment.

TABLE 1
Summary of facial representations for generative face video compression algorithms

| Facial | |
|---|---|
| Representation | Interpretation |
| 2D | VSBNet can be the representative model which can utilize 98 groups |
| landmarks | of 2D facial landmarks [symbol] ^{2×98} to depict the key structure information of |
| | human face, where the total number of encoding parameters for each inter |
| | frame is 196. |
| 2D keypoints + | FOMM can be the representative model which adopts 10 groups of |
| affine | learned 2D keypoints [symbol] ^{2×10} along with their local affine transformations |
| transformation | [symbol] ^{2×2×10} to characterize complex motions. The total number of encoding |
| matrix | parameters for each inter frame is 60. |
| region | Motion Representations for Articulated Animation (MRAA) can be |
| matrix | the representative model which extracts consistent regions of talking face to |
| | describe locations, shape, and pose, mainly represented with shift matrix |
| | [symbol] ^{2×10}, covar matrix [symbol] ^{2×2×10} and affine matrix [symbol] ^{2×2×10}. As such, the total |
| | number of encoding parameters for each inter frame is 100. |
| 3D | Face_vid2vid can be the representative model which can estimate 12- |
| keypoints | dimension head parameters (i.e., rotation matrix [symbol] ^{3×3} and translation |
| | parameters [symbol] ^{3×1}) and 15 groups of learned 3D keypoint perturbations |
| | [symbol] ^{3×15} due to facial expressions, where the total number of encoding |
| | parameters for each inter frame is 57. |
| compact | CFTE can be the representative model which can model the temporal |
| feature matrix | evolution of faces into learned compact feature representation with the |
| | matrix [symbol] ^{4×4}, where the total number of encoding parameters for each inter |
| | frame is 16. |
| facial | Interactive Face Video Coding (IFVC) can be the representative |
| semantics | model which adopts a collection of transmitted facial semantics to represent |
| | the face frame, including mouth parameters [symbol] ⁶, eye parameter [symbol] ¹, rotation |
| | parameters [symbol] ³, translation parameters [symbol] ³ and location parameter [symbol] ¹. |
| | Totally, the number of encoding parameters for each inter frame is 14. |

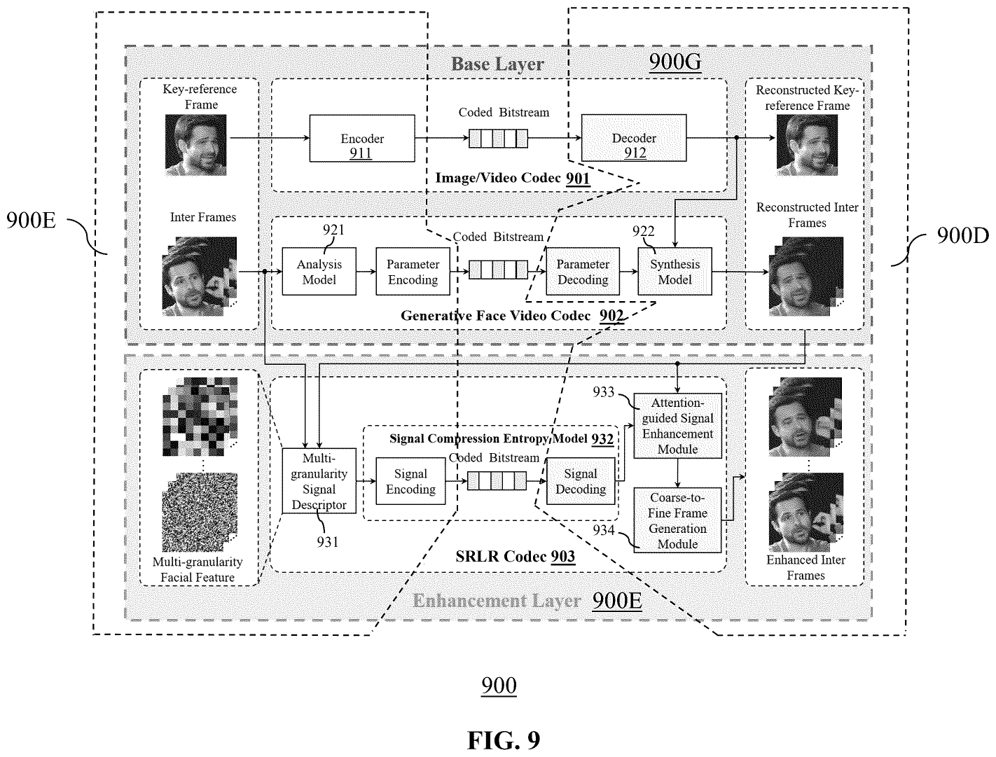

FIG. 9 is a schematic diagram illustrating an exemplary Pleno-Generation (PGen) framework 200 based on scalable representation and layered reconstruction (SRLR) for bandwidth-intelligent face video communication, according to some embodiments of the present disclosure. PGen framework 900 is rooted in the widely accepted view that face frames own prior statistics and can be automatically characterized as meaningful representations, such as latent code (e.g., keypoints, facial semantics, and compact features) and enriched signal (e.g., residual signal, segmentation map, and dense flow). These facial representations may also align with the recent neuroscience hypothesis that Human Visual System (HVS) can achieve the straighter transformation from overall visual signals to key motion trajectories. As shown in FIG. 9, The SRLR-based PGen framework 900 for intelligent-bandwidth face video communication may include base and enhancement layers. Moreover, an encoder 900E can be used to generate coded bitstreams (e.g., including three respective coded bitstreams shown in FIG. 9) representing the base layer and the enhancement layer of a picture, while a decoder 900D can be used to reconstruct the picture. In addition, SRLR-based PGen framework 900 can be divided into an upper part 900G for processing base layer and a lower part 900E for processing enhancement layer.

In some embodiments, the key-reference frames of the base layer can be encoded with conventional approaches, where image/video 901 may be compatible with High Efficiency Video Coding (HEVC/H.265) standard, the Versatile Video Coding (VVC/H.266) standard, AVS standards, for example. An encoder 911 can be used to compress the key-reference frames into a coded bitstream, while a decoder 912 can be used to decode the coded bitstream into reconstructed key-reference frames. In addition, the inter frames of the base layer, which can be encoded with reference to the key-reference frames, can be compatible with the GFVC algorithms and achieve ultra-low bitrate face video communication with compact representations. The face data can be characterized with latent code (e.g., keypoints, facial semantics or compact feature) at encoder 900E (Specifically, by an analysis model 921), and the extracted information is further compressed through a parameter encoding process and conveyed (e.g., by a coded bitstream) to reconstruct the face via the deep generative model at decoder 900D. Specifically, the coded bitstream can be decompressed through a parameter decoding process into the extracted information. The extracted information and the reconstructed key-reference frames can then be processed by synthesis model 922 for reconstructing the face data and the inter frames with a base layer. A generative face video codec 902, which includes analysis model 921 and synthesis model 922, may be compatible with the GFVC algorithms described above.

Afterwards, the enhancement layer is capable of providing enriched facial signals and supporting high-quality face video communication when bandwidth permits. The enhancement layer can be processed with an SRLR code 903. Specifically, encoder 900E can further characterize visual face data with different-granularity facial signals by a multi-granularity facial signal descriptor 931 and compress them into a coded bitstream through a signal encoding process by a signal compression entropy model 932, while the decoder side receives the coded bitstream and decompresses the coded bitstream through a signal decoding process by signal compression entropy model 932. Furthermore, the decoder side may exploit these decoded auxiliary facial signals to improve the reconstruction quality of the base-layer output frames. Specifically, the decoded data through the signal encoding process can then be fed into an attention-guided signal enhancement module 933 along with the reconstructed inter frames with the base layer. Then, the result from attention-guided signal enhancement module 933 can be input into a coarse-to-fine frame generation module to generate enhanced inter frames.

As can be appreciated, PGen framework 900 achieves several potential benefits and enables promising face communication scenarios, where the corresponding analyses are listed as follows.
Coding flexibility. The face data is able to be characterized with compact representation and enriched signal, which can be naturally incorporated into a unified PGen framework 900. In particular, the conceptually-explicit visual information can be entailed into the segment-able and ability-interpret bitstream, such that they can be partially transmitted and decoded to actualize different-layer visual reconstruction in the specific bandwidth environment. As such, the coding flexibility can be well guaranteed.
Perceptual quality improvement. PGen framework 900 can well optimize the reconstruction quality limitations of the GFVC algorithms such as occlusion artifacts, low face fidelity and poor local motion. In particular, with the guidance of auxiliary visual signal, the base-layer motion estimation errors can be perceptually compensated and the long-term dependencies among face frames can be accurately regularized. As a consequence, the enhancement-layer output can greatly improve the reconstruction quality and even tend to the pixel-level reconstruction with faithful representation of texture and motion.
Universally plug-and-play component. PGen framework 900 may strictly follow the scalable philosophy and include the base-enhancement layers. In particular, the enhancement layer is designed as a universally plug-and-play component to warrant the service of the base layer that is compatible with the GFVC algorithms. In addition to the flexibility of external component, the internal mechanism of the enhancement layer is very flexible, which can realize different-granularity signal representation and support different-quality face video communication according to the requirements of the bandwidth environment.

Supplemental Enhancement Information (SEI) is a type of data in video coding. It contains additional metadata that can be associated with video pictures, which is beneficial for more advanced video processing and decoding. For example, SEI messages are intended to be conveyed within the coded video bitstream in a manner specified in a video coding specification or to be conveyed by other means determined by the specifications for systems that make use of such coded video bitstream. SEI messages can contain various types of data that indicate the timing of the video pictures or describe various properties of the coded video or how it can be used or enhanced. SEI messages can also be defined as those that can contain arbitrary user-defined data. SEI messages do not affect the core decoding process, but can indicate how the video is recommended to be post-processed or displayed.

In the meetings of Joint Video Experts Team (JVET), it was proposed to signal the features extracted from the face video at the encoder side via an SEI message. After the decoder receives the bitstreams, the SEI message can be decoded and the features can then be reconstructed. Then the face video is generated with a generative model after decoding. To provide the texture of the face, the first picture (also called key frame or base picture) of the face video can be coded with traditional video codec, such as VVC codec. With this method, the decoder that conforms to the current video coding standard doesn't need to be modified and only a generative model needs to be added as a post-processor.

However, all those SEI messages proposed only support transmitting the base layer features (also referred to as the base features herein) for the generative face video coding. With the development of the scalable generative face video coding, to transmit the features of the enhancement layer (also referred to as the enhancement features herein) to get a better perceptual quality of the generative video, a new syntax design of generative face video SEI message is proposed in this disclosure.

The present disclosure provides methods and apparatuses to solve one or more of the above-described problems by providing a new syntax design for signaling features of an enhancement layer. For example, a flag indicating the presence of the enhancement layer can be signaled in the SEI message. Thus, the decoder can determine whether to enhance the reconstructed frames based on an enhancement layer. A flag indicating the presence of certain elements that represent the features of the enhancement layer can be signaled in the SEI message. The decoder can determine whether to retrieve the elements from the SEI message based on the flag. Moreover, if enhancement layer features are also signalled, a generative model can generate a higher quality face image based on base layer features and enhancement layer features.

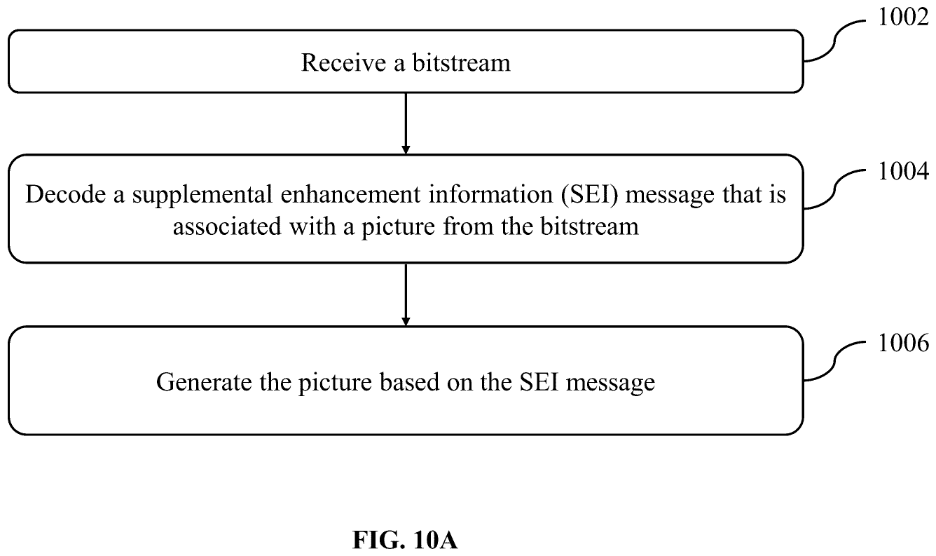

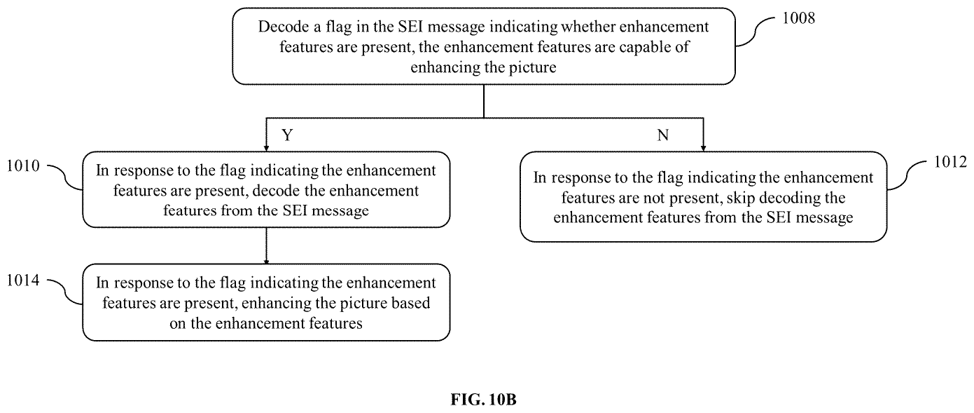

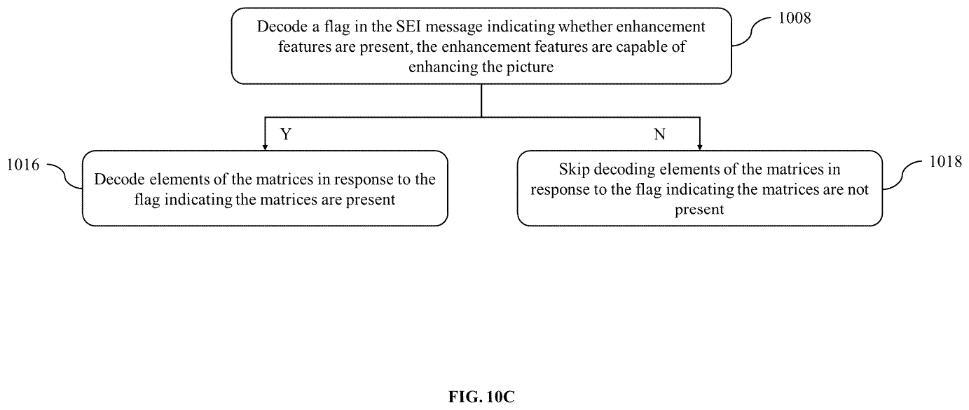

In some embodiments, a video decoding method is provided. FIG. 10A is a flowchart of an exemplary video decoding method 1000, according to some embodiments of the present disclosure. As shown in FIG. 10A, method 1000 may include the following steps 1002 to 1006, which can be performed by a decoder (e.g., image/video decoder 144 shown in FIG. 1 or decoder 900D shown in FIG. 9). In some embodiments, image/video decoder 144 may be integrated into apparatus 400 shown in FIG. 4, such that method 1000 can be performed by apparatus 400.

In step 1002, the decoder may receive a bitstream from an encoder (e.g., image/video encoder 124 in FIG. 1, apparatus 400 in FIG. 4, or decoder 900D shown in FIG. 9) or content distribution operator. As appreciated, the bitstream may include coded information of a series of pictures. In some embodiments, the SEI message can be signalled before a GOP (Group of Pictures), which can be decoded along with the pixel content of the picture.

In step 1004, the decoder may decode a supplemental enhancement information (SEI) message that is associated with a picture from the bitstream. The SEI message may include syntax elements that indicate features of a base layer and an enhancement layer of the picture. The features of the base layer apply to a generative model, while the base layer can be enhanced by an enhancement model with the features of the enhancement layer. In some embodiments, the generative model can be implemented by part 900G, and the enhancement model can be implemented by part 900E shown in FIG. 9, for example.

In step 1006, the decoder may generate the picture based on the SEI message decoded in step 1004. In some embodiments, the decoder may generate the picture, via a generative model and an enhancement model, based on the base features and the enhancement features. In some embodiments, the decoded SEI message may include enhancement features associated with the picture. The decoder can enhance the picture with the enhancement features.

In some embodiments, the SEI message may include a flag indicating whether the enhancement layer is present. For example, for the signaling of the features of enhancement layer, a gating flag can be included in the SEI message. If the gating flag indicates the enhancement layer is present, the features of the enhancement layer can then be signaled; otherwise, the signaling of the enhancement layer features can be skipped.

FIG. 10B is flowchart illustrating sub-steps of exemplary video decoding method 1000 shown in FIG. 10A, according to some embodiments of the present disclosure. Step 1004 can be further implemented in sub-steps 1008 to 1012. As shown in FIG. 10B, the decoder may decode a flag (e.g., gfv_enhance_info_present_flag show in Table 2) in the SEI message indicating whether enhancement features are present, in step 1008. As described herein, the enhancement features can be used to enhance the picture. In step 1010, the decoder may decode the enhancement features from the SEI message in response to the flag indicating the enhancement features are present. In step 1012, the decoder may skip decoding the enhancement features from the SEI message in response to the flag indicating the enhancement features are not present. Subsequently, in step 1014, the decoder may enhance the picture based on the enhancement features in response to the flag indicating the enhancement features are present.

In some embodiments, the SEI message may include matrices that represent the enhancement features. FIG. 10C is flowchart illustrating sub-steps of exemplary video decoding method 1000 shown in FIG. 10A, according to some embodiments of the present disclosure. Step 1004 can be further implemented in sub-steps 1008, 1016 and 1012. As describe above, the decoder may decode a flag (e.g., gfv_enhance_info_present_flag show in Table 2) in the SEI message indicating whether enhancement features are present, in step 1008. In step 1016, the decoder may decode elements of the matrices in response to the flag indicating the matrices are present. In step 1018, the decoder may skip decoding elements of the matrices in response to the flag indicating the matrices are not present. As can be appreciated, the decoder may enhance the picture based on the decoded matrices, if any.

In some embodiments, the decoder may generate the picture based on the features of the base layer and the enhancement layer when the enhancement layer is present. Otherwise, the decoder may generate the picture based on the features of the base layer when the enhancement layer is not present. Subsequently, if the enhancement layer features are also signaled (e.g., in the SEI), the generative model can generate a face picture with higher quality based on base layer features and enhancement layer features.

As described above, the features of the enhancement layer can be represented by matrices. The number of the matrices and the dimension of the matrices can also be signaled, followed by each element of the matrices. In some embodiments, the enhancement layer features can also be represented by key-points, or both by matrices and key-points. When signaling the element values of the matrices or the coordinates of the key-points, one way is to directly signal the value and the other way is to do predictive signaling. That is, the only difference between the current element and the previous element is signaled to reduce the signaling overhead.

In some embodiments, the SEI message may include a flag (e.g., gfv_enhance_matrix_element_sign_flag as shown Table 2) indicating whether an element of the matrices (e.g., gfv_enhance_matrix_element as shown Table 2) is present.

For example, the design of the SEI message is shown in Table 2, in which the major changes to the traditional SEI message syntax are italicized.

TABLE 2
Syntax of generative face video SEI message

| | Descriptor |
|---|---|
| generative_face_video ( payloadSize ) { | |
| gfv_id | ue(v) |
| gfv_cnt | ue(v) |
| gfv_base_pic_flag /*indicate if current decoded output picture is a | u(1) |
| base picture*/ | |
| if( gfv_base_pic_flag ) { /*specify TranslatorNN( )*/ | |
| gfv_nn_present_flag | u(1) |
| if( gfv_nn_present_flag ) { | |
| gfv_nn_base_flag | u(1) |
| gfv_nn_mode_idc | ue(v) |
| if( gfv_nn_mode_idc = = 1 ) { | |
| while( !byte_aligned( ) ) | |
| gfv_nn_reserved_zero_bit_a | u(1) |
| gfv_nn_tag_uri | st(v) |
| gfv_nn_uri | st(v) |
| } | |
| } | |
| } else /* current decoded output picture is a driving picture*/ | |
| gfv_drive_pic_fusion_flag /*indicate if DrivePicture is input to | ue(v) |
| GenerativeNN( )*/ | |
| gfv_low_confidence_face_parameter_flag | u(1) |
| gfv_coordinate_present_flag | u(1) |
| if( gfv_coordinate_present_flag ) { | |
| gfv_kp_pred_flag | u(1) |
| if( gfv_base_pic_flag \| \| !gfv_kps_pred_flag ) { | |
| gfv_coordinate_precision_factor_minus1 | ue(v) |
| gfv_num_kps_minus1 | ue(v) |
| gfv_coordinate_z_present_flag | u(1) |
| if(gfv_coordinate_z_present_flag ) | |
| gfv_coordinate_z_max_value_minus1 | ue(v) |
| } | |
| for( i = 0; i <= num_kps_minus1; i++ ) { | |
| if(!gfv_kp_pred_flag) { | |
| gfv_coordinate_x_abs[ i ] | u(v) |
| if( gfv_coordinate_x_abs[ i ] ) | |
| gfv_coordinate_x_sign_flag[ i ] | u(1) |
| gfv_coordinate_y_abs[ i ] | u(v) |
| if( gfv_coordinate_y_abs[ i ] ) | |
| gfv_coordinate_y_sign_flag[ i ] | u(1) |
| if( gfv_coordinate_z_present_flag ) { | |
| gfv_coordinate_z_abs[ i ] | u(v) |
| if( gfv_coordinate_z_abs[ i ] ) | |
| gfv_coordinate_z_sign_flag[ i ] | u(1) |
| } | |
| } else { | |
| gfv_coordinate_dx_abs[ i ] | u(v) |
| if(gfv_coordinate_dx_abs[ i ] ) | |
| gfv_coordinate_dx_sign_flag[ i ] | u(1) |
| gfv_coordinate_dy_abs[ i ] | u(v) |
| if( gfv_coordinate_dy_abs[ i ] ) | |
| gfv_coordinate_dy_sign_flag[ i ] | u(1) |
| if( gfv_coordinate_z_present_flag ) { | |
| gfv_coordinate_dz_abs[ i ] | u(v) |
| if( gfv_coordinate_dz_abs[ i ] ) | |
| gfv_coordinate_dz_sign_flag[ i ] | u(1) |
| } | |
| } | |
| } | |
| } | |
| gfv_matrix_present_flag | u(1) |
| if(gfv_matrix_present_flag ) { | |
| if( !gfv_base_pic_flag ) | |
| gfv_matrix_pred_flag | u(1) |
| if( !gfv_matrix_pred_flag ) { | |
| gfv_matrix_element_precision_factor_minus1 | |
| gfv_num_matrix_types_minus1 | |
| for( i= 0; i <= num_matrix_types_minus1; i++ ) { | |
| gfv_matrix_type_idx[ i ] | u(6) |
| if( | |
| gfv_matrix_type_idx[ i] = = 0 \| \| gfv_matrix_type_idx[ i ] = = 1 ) { | |
| if( gfv_coordinate_present_flag ) | |
| gfv_num_matrices_equal_to_num_kps_flag[ i ] | u(1) |
| if(!gfv_coordinate_present_flag \| \| !gfv_num_matrix_equal_to_num_kps_fl | |
| ag[ i ] ) | |
| gfv_num_matrices_info[ i ] | ue(v) |
| }else | |
| if(gfv_matrix_type_idx[ i ] = = 2 \| \| gfv_matrix_type_idx[ i ] = = 3 \| \| | |
| gfv_matrix_type_idx[ i ] >= 7){ | |
| if( gfv_matrix_type_idx[ i ] >= 7 ) | |
| gfv_num_matrices_minus1 [ i ] | ue(v) |
| gfv_matrix_width_minus1[ i ] | ue(v) |
| gfv_matrix_height_minus1[ i ] | ue(v) |
| }else | |
| if( | |
| gfv_matrix_type_idx[ i ] >= 4 && gfv_matrix_type_idx[ i ] <= 6 && | |
| !gfv_coordinate_present_flag ){ | |
| gfv_matrix_for_3D_space_flag[ i ] | u(1) |
| } | |
| } | |
| for( i = 0; i <= num_matrix_types_minus1; i++ ) { | |
| for( j = 0; j < numMatrices[ i ]; j++ ) | |
| for( k = 0; k < matrixHeight[ i ]; k++ ) | |
| for( m = 0; m <matrixWidth[ i ]; m++ ) { | |
| if( !gfv_matrix_pred_flag ) { | |
| gfv_matrix_element_int[ i ][ j ][ k ][ m ] | ue(v) |
| gfv_matrix_element_dec[ i ][ j ][ k ][ m ] | u (v) |
| if( | |
| gfv_matrix_element_int[ i][ j ][ k ][ m ] \| \| gfv_matrix_element_{—} | |
| dec[ i ][ j ][ k ][ m ] ) | |
| gfv_matrix_element_sign_flag[ i ][ j ][ k ][ m ] | u(1) |
| } | |
| else { | |
| gfv_matrix_delta_element_int[ i ][ j ][ k ][ m ] | ue(v) |
| gfv_matrix_delta_element_dec[ i ][ j ][ k ][ m ] | u (v) |
| if(gfv_matrix_delta_element_int[ i][ j ][ k ][ m ] \| \| gfv_matrix_delta_eleme | |
| nt_dec[ i ][ j ][ k ][ m ] ) | |
| gfv_matrix_delta_element_sign_flag[ i ][ j ][ k ][ m ] | u(1) |
| } | |
| } | |
| } | |
| } | |
| gfv_{—}enhance_{—}info_{—}present_{—}flag | u(1) |
| if( gfv_{—}enhance_{—}info_{—}present_{—}flag ) { | |
| gfv_{—}enhance_{—}matrix_{—}element_{—}precision_{—}factor_{—}minnus1 | ue(v) |
| gfv_{—}num_{—}enhance_{—}matrice_{—}minus1 | ue(v) |
| for(i=0; i <= gfv_{—}num_{—}enhance_{—}matrice_{—}minus1; i++){ | |
| gfv_{—}enhance_{—}matrix_{—}height_{—}minus1[ i ] | ue(v) |
| gfv_{—} enhance_{—}matrix_{—}width_{—}minus1[ i ] | ue(v) |
| for( j = 0; j <= gfv_{—}enhance_{—}matrix_{—}height_{—}minus1[ i ]; j++ ) | |
| for( k = 0; k <= gfv_{—}enhance_{—}matrix_{—}width_{—}minus1[ i ]; | |
| k++ ) { | |
| gfv_{—}enhance_{—}matrix_{—}element [ i ][ j ][ k ] | ue(v) |
| if( ! gfv_{—}enhance_{—}matrix_{—}element [ i ][ j ][ k ]) | |
| gfv_{—}enhance_{—}matrix_{—}element_{—}sign_{—}flag [ i ][ j ][ k ] | u(1) |
| } | |
| } | |
| } | |
| } | |
| if( gfv_nn_present_flag ) | |
| if( gfv_nn_mode_idc = = 0 ) { | |
| while( !byte_aligned( ) ) | |
| gfv_nn_reserved_zero_bit_b | u(1) |
| for( i = 0; more_data_in_payload( ); i++ ) | |
| gfv_nn_payload_byte[ i ] | b(8) |
| } | |
| } | |

As can be appreciated, the generative face video (GFV) SEI message can be used to carry facial parameters and indicate a facial parameter translator network, denoted as TranslatorNN ( ) that may be used to convert various formats of facial parameters signaled in the SEI message into a particular facial parameter format supported by the decoding system. A face picture generator neural network, denoted as GenerativeNN ( ) that may be used to generate output pictures using the facial parameters translated and previously decoded output pictures. In addition, a face picture enhancer EnhanceNN ( ) may be used to enhance the picture generated by the GenerativeNN ( ) to get an enhanced face picture.

In some embodiments, when a picture unit contains a GFV SEI message with a particular gfv_id value and gfv_base_pic_flag equal to 1, the picture in the picture unit is referred to as a base picture for that particular gfv_id value. When a picture unit contains a GFV SEI message with a particular gfv_id value and gfv_base_pic_flag equal to 0, and the picture unit does not contain a GFV SEI message with that particular gfv_id value and gfv_base_pic_flag equal to 1, the picture in the picture unit is referred to as a driving picture for that particular gfv_id value. When a picture unit contains a GFV SEI message with a particular gfv_id value, gfv_base_pic_flag equal to 0, and gfv_drive_pic_fusion_flag equal to 1, and the picture unit does not contain a GFV SEI message with that particular gfv_id value and gfv_base_pic_flag equal to 1, the picture in the picture unit is referred to as a fusion picture for that particular gfv_id value.

In some embodiments, facial parameters can be determined from source pictures prior to encoding. Such source pictures may be referred to as driving pictures.

Previously decoded output pictures input to GenerativeNN ( ) may be a base picture (a decoded output picture that provides the reference texture from which the face pictures may be generated) and, optionally, a picture that can be fused by GenerativeNN ( ) to improve background texture and facial details. When the current picture is not a base picture, the GFV SEI message may be used to generate a face picture based on the previously decoded base picture, the facial parameters conveyed by the GFV SEI message, and, optionally, the current decoded picture for fusion purpose.

After GenerativeNN ( ) generates the face picture, if the enhancement information is present, the generated face picture can be further fed into EnhanceNN ( ) with the enhancement feature to get improved face picture.

Use of this SEI message may require the definition of the following variables.
Input picture width and height in units of luma samples, denoted herein by CroppedWidth and CroppedHeight, respectively.
Luma sample array, denoted by CroppedYPic and chroma sample arrays, denoted by CroppedCbPic and CroppedCrPic for an input picture corresponding to a decoded output picture.

Bit depth BitDepthY for the luma sample array of the input pictures.
Bit depth BitDepthC for the chroma sample arrays, if any, of the input pictures.
A chroma format indicator, denoted herein by ChromaFormatIdc.

The variables SubWidthC and SubHeightC are derived from ChromaFormatIdc.

gfv_id contains an identifying number that may be used to identify face feature information and specify a neural network that may be used as TranslatorNN ( ) The value of gfv_id shall be in the range of 0 to 2³²-2, inclusive. Values of gfv_id from 256 to 511, inclusive, and from 231 to 2³²-2, inclusive, are reserved for future use by ITU-T|ISO/IEC. Decoders conforming to this edition of this document encountering a GFV SEI message with gfv_id in the range of 256 to 511, inclusive, or in the range of 231 to 2³²-2, inclusive, shall ignore the SEI message.

Different values of gfv_id in different GFV SEI messages can be used to identify different TranslatorNN ( ) and GnerativeNN ( ) for example.

gfv_cnt specifies a GFV SEI message instance count value for this gfv_id value within a picture unit.

The gfv_cnt of the first GFV SEI message, in decoding order, with a particular value of gfv_id within picture unit shall be equal to 0. When gfv_cnt assigned to currGfvCnt is greater than 0, a GFV SEI message with the same gfv_id value and gfv_cnt equal to currGfvCnt-1 shall precede the current GFV SEI message in decoding order in the same picture unit.

The value of gfv_cnt shall be in the range of 0 to 65 535, inclusive.

gfv_base_pic_flag equal to 1 indicates the current decoded output picture corresponds to a base picture and this SEI message specifies syntax elements for a base picture. gfv_base_pic_flag equal to 0 indicates the current decoded output picture does not correspond to a base picture or this SEI message does not specify syntax elements for a base picture. When gfv_cnt is greater than 0, gfv_base_pic_flag shall be equal to 0.

The following constraints apply to the value of gfv_base_pic_flag:
When a GFV SEI message is the first GFV SEI message, in decoding order, that has a particular gfv_id value within the current CLVS, the value of gfv_base_pic_flag shall be equal to 1.
When a GFV SEI message that has a particular gfv_id value has gfv_base_pic_flag being equal to 0, the base picture for that particular gfv_id value, which is the current cropped decoded picture, remains valid to the current decoded picture and all subsequent decoded pictures of the current layer, in output order, until the end of the current CLVS or up to but excluding the decoded picture that follows the current decoded picture in output order within the current CLVS and is associated with a GFV SEI message having that particular gfv_id value and gfv_base_pic_flag equal to 1.

gfv_nn_present_flag equal to 1 indicates a neural network that may be used as a TranslatorNN ( ) is contained or indicated by the SEI message. gfv_nn_present_flag equal to 0 indicates a neural network that may be used as a TranslatorNN ( ) is not contained or indicated by the SEI message. When gfv_nn_present_flag is not present, it is inferred to be 0.

When gfv_nn_present_flag is equal to 0 and TranslatorNN is referenced in the semantics of the GFV SEI message, the following constraint applies:
If gfv_cnt is equal to 0, there shall be at least one GFV SEI message present in a preceding picture unit in output order in the current CLVS and having the same value of gfv_id as that in the current GFV SEI message and gfv_nn_present_flag equal to 1.
Otherwise (gfv_cnt is greater than 0), there shall be at least one GFV SEI message that is present in either the current picture unit or a preceding picture unit in output order in the current CLVS and has the same value of gfv_id as that in the current GFV SEI message and gfv_nn_present_flag equal to 1.

When gfv_nn_present_flag is equal to 0 and TranslatorNN is referenced in the semantics of this SEI message, the following applies for deriving the applicable TranslatorNN:
If gfv_cnt is greater than 0 and there exists one or more preceding GFV SEI messages in decoding order in the current picture unit that has the same value of gfv_id as that in the current GFV SEI message and gfv_nn_present_flag equal to 1, the applicable TranslatorNN is defined by the last preceding GFV SEI message in decoding order in the current picture unit that has the same value of gfv_id as that in the current GFV SEI message and gfv_nn_present_flag equal to 1.
Otherwise, the applicable TranslatorNN is defined by a GFV SEI message that is present in the last preceding picture unit puB in output order in the current CLVS that has the same value of gfv_id as the current GFV SEI message and gfv_nn_present_flag equal to 1. When there are multiple such GFV SEI messages present in the picture unit pub that have the same value of gfv_id as the current GFV SEI message and gfv_nn_present_flag equal to 1, the applicable TranslatorNN is defined by the last of such GFV SEI messages in decoding order

gfv_nn_base_flag, gfv_nn_mode_idc, gfv_nn_reserved_zero_bit_a, gfv_nn_tag_uri, gfv_nn_uri, gfv_nn_payload_byte[i] specify a neural network that may be used as a TranslatorNN ( ) gfv_nn_base_flag, gfv_nn_mode_idc, gfv_nn_reserved_zero_bit_a, gfv_nn_tag_uri, gfv_nn_uri, gfv_nn_payload_byte[i] have the same syntax and semantics as nnpfc_base_flag, nnpfc_mode_idc, nnpfc_reserved_zero_bit_a, nnpfc_tag_uri, nnpfc_uri, nnpfc_payload_byte[i], respectively.

The GFV SEI messages that are present in the same picture unit and have the same values of gfv_id and gfv_cnt shall have the same SEI payload content.

When either of the following conditions is true, GFV SEI messages shall have the same SEI payload content:
The GFV SEI messages are present in the same picture unit, have gfv_cnt equal to 0, have gfv_nn_base_flag present, and have the same value of gfv_id and gfv_nn_base_flag,
The GFV SEI messages are present in the same picture unit, have the same value of gfv_cnt that is greater than 0, and have the same value of gfv_id.

gfv_drive_pic_fusion_flag, when present, equal to 1 indicates the current decoded picture, which corresponds to a driving picture that may be used for fusion, may be input to GenerativeNN ( ) gfv_drive_pic_fusion_flag equal to 0 indicates the current decoded picture should not be input to GenerativeNN ( ).

A gfv_drive_pic_fusion_flag value of 1 can be used, for example, to indicate that the current decoded picture can be used to improve face details or handle background changes.

When gfv_base_pic_flag is equal to 0 and gfv_drive_pic_fusion_flag is equal to 1, the GFV process takes three inputs: the base picture, features from keypoints and/or matrices carried in the GFV SEI message, and the current decoded picture that is a fusion picture, and outputs a picture that is generated by the GenerativeNN ( ).

When gfv_base_pic_flag is equal to 0 and gfv_drive_pic_fusion_flag is equal to 0, the GFV process takes two inputs: the base picture and features from keypoints and/or matrices carried in the GFV SEI message, and outputs a picture that is generated by the GenerativeNN ( ).

When gfv_base_pic_flag is equal to 1, the GFV process directly outputs the cropped decoded picture

Fusion takes the three inputs: the base picture, features from keypoints and/or matrices carried in the GFV SEI message, and the current decoded picture, and outputs a picture.

When current decoded picture corresponds to a driving picture, it should be marked as not for output purpose.

When a GFV SEI message has gfv_base_pic_flag equal to 0 and gfv_drive_pic_fusion_flag equal to 0, the GFV SEI message pertains to the current decoded picture only

When a GFV SEI message with a particular gfv_id value has gfv_base_pic_flag equal to 0 and gfv_drive_pic_fusion_flag equal to 1, the fusion picture for that particular gfv_id value, which is the current cropped decoded picture, remains valid for the current decoded picture and all subsequent decoded pictures of the current layer, in output order, until the end of the current CLVS or up to but excluding the decoded picture that is within the current CLVS, follows the current decoded picture in output order, and is associated with a GFV SEI message having that particular gfv_id value, whichever is earlier.

When a GFV SEI message gfvSeiA with a particular gfv_id value has gfv_cnt greater than 0 and a GFV SEI message gfvSeiB with the same gfv_id value in the same picture unit has gfv_base_pic_flag equal to 1 (i.e., the current decoded picture is a base picture), the GFV SEI message gfvSeiA shall have gfv_drive_pic_fusion_flag equal to 0.

gfv_low_confidence_face_parameter_flag equal to 1 indicates the facial parameters have been derived with low confidence. gfv_low_confidence_face_parameter_flag equal to 0 indicates the confidence information of the facial parameters is not specified.

gfv_coordinate_present_flag equal to 1 indicates that coordinate information of keypoints is present. gfv_coordinate_present_flag equal to 0 indicates that coordinate information of keypoints is not present.

It is a requirement of bitstream conformance that when gfv_matrix_type_idx[i] for any i from 0 to gfv_num_matrix_types_minus1 is equal to 0 or 1, the value of gfv_coordinate_present_flag shall be equal to 1.

gfv_kps_pred_flag equal to 1 indicates that the syntax elements gfv_coordinate_dx_abs[i], gfv_coordinate_dy_abs[i], and gfv_coordinate_dz_abs[i] are present and the syntax elements gfv_coordinate_dx_sign_flag[i], gfv_coordinate_dy_sign_flag[i] and gfv_coordinate_dz_sign_flag[i] may be present. gfv_kps_pred_flag equal to 0 indicates that the syntax elements gfv_coordinate_x_abs[i], gfv_coordinate_y_abs[i], and gfv_coordinate_z_abs[i] are present and the syntax elements gfv_coordinate_x_sign_flag[i], gfv_coordinate_y_sign_flag[i] and gfv_coordinate_z_sign_flag[i] may be present.

gfv_coordinate_precision_factor_minus1 plus 1 indicates the precision of key point coordinates signalled in the SEI message. The value of gfv_coordinate_precision_factor_minus1 shall be in the range of 0 to 31, inclusive. When gfv_coordinate_present_flag is equal to 1, gfv_base_pic_flag is equal to 0, and gfv_kps_pred_flag is equal to 1, the value of gfv_coordinate_precision_factor_minus1 is inferred to be equal to the gfv_coordinate_precision_factor_minus1 of the previous GFV SEI message in decoding order with the same gfv_id as the current GFV SEI message and gfv_base_pic_flag equal to 1.

gfv_num_kps_minus1 plus 1 indicates the number of keypoints. The value of gfv_num_kp_minus1 shall be in the range of 0 to 2¹⁰-1, inclusive. When gfv_coordinate_present_flag is equal to 1, gfv_base_pic_flag is equal to 0, and gfv_kps_pred_flag is equal to 1, the value of gfv_num_kps_minus1 is inferred to be equal to the gfv_num_kps_minus1 of the previous GFV SEI message in decoding order with the same gfv_id as the current GFV SEI message and gfv_base_pic_flag equal to 1.

gfv_coordinate_z_present_flag equal to 1 indicates that z-axis coordinate information of the keypoints is present. gfv_coordinate_z_present_flag equal to 0 indicates that the z-axis coordinate information of the keypoints is not present.

When gfv_coordinate_z_present_flag is not present, it is inferred as follows:
If gfv_coordinate_present_flag is equal to 1, gfv_base_pic_flag is equal to 0 and gfv_kps_pred_flag is equal to 1, the value of coordinate_z_present_flag is inferred to be equal to the coordinate_z_present_flag of the previous GFV SEI message in decoding order with the same gfv_id as the current GFV SEI message and gfv_base_pic_flag equal to 1.
Otherwise, the value of coordinate_z_present_flag is inferred to be equal to 0.

gfv_coordinate_z_max_value_minus1 plus 1 indicates the maximum absolute value of z-axis coordinates of keypoints. The value of gfv_coordinate_z_max_value_minus1 shall be in the range of 0 to 2¹⁶-1, inclusive. When gfv_coordinate_present_flag is equal to 1, gfv_base_pic_flag is equal to 0, and gfv_kps_pred_flag is equal to 1, the value of gfv_coordinate_z_max_value_minus1 is inferred to be equal to the gfv_coordinate_z_max_value_minus1, when present, in the previous GFV SEI message in decoding order with the same gfv_id as the current GFV SEI message and gfv_base_pic_flag equal to 1.

gfv_coordinate_x_abs[i] indicates the normalized absolute value of the x-axis coordinate of the i-th keypoint. The value of gfv_coordinate_x_abs[i] shall be in the range of 0 to 2^{gfv_coordinate_precision_factor_minus1+1} inclusive.

gfv_coordinate_x_sign_flag[i] specifies the sign of the x-axis coordinate of the i-th keypoint. When gfv_coordinate_x_sign_flag[i] is not present, it is inferred to be equal to 0.

gfv_coordinate_y_abs[i] specifies the normalized absolute value of y-axis coordinate of i-th keypoint. The value of gfv_coordinate_y_abs[i] shall be in the range of 0 to 2^{gfv_coordinate_precision_factor_minus1+1} inclusive.

gfv_coordinate_y_sign_flag[i] specifies the sign of the y-axis coordinate of the i-th keypoint. When gfv_coordinate_y_sign_flag[i] is not present, it is inferred to be equal to 0.

gfv_coordinate_z_abs[i] specifies the normalized absolute value of z-axis coordinate of the i-th keypoint. The value of gfv_coordinate_z_abs[i] shall be in the range of 0 to 2^{gfv_coordinate_precision_factor_minus1+1} inclusive.

gfv_coordinate_z_sign_flag[i] specifies the sign of the z-axis coordinate of the i-th key point. When gfv_coordinate_z_sign_flag[i] is not present, it is inferred to be equal to 0.

gfv_coordinate_dx_abs[i] indicates the absolute difference value of the normalized value of the x-axis coordinate of the i-th keypoint. The value of gfv_coordinate_dx_abs[i] shall be in the range of 0 to 2^{gfv_coordinate_precision_factor_minus1+2}, inclusive.

gfv_coordinate_dx_sign_flag[i] specifies the sign of the difference value of the x-axis coordinate of the i-th keypoint. When gfv_coordinate_dx_sign_flag[i] is not present, it is inferred to be equal to 0.

gfv_coordinate_dy_abs[i] specifies the absolute difference value of the normalized y-axis coordinate of the i-th keypoint. The value of gfv_coordinate_dy_abs[i] shall be in the range of 0 to 2^{gfv_coordinate_precision_factor_minus1+2}, inclusive.

gfv_coordinate_dy_sign_flag[i] specifies the sign of the difference value of the y-axis coordinate of the i-th keypoint. When gfv_coordinate_dy_sign_flag[i] is not present, it is inferred to be equal to 0.

gfv_coordinate_dz_abs[i] specifies the absolute difference value of the normalized z-axis coordinate of the i-th keypoint. The value of gfv_coordinate_dz_abs[i] shall be in the range of 0 to 2^{gfv_coordinate_precision_factor_minus1+2}, inclusive.

gfv_coordinate_dz_sign_flag[i] specifies the sign of the difference value of the z-axis coordinate of the i-th key point. When gfv_coordinate_dz_sign_flag[i] is not present, it is inferred to be equal to 0.

If gfv_coordinate_z_max_value_minus1 is present, the variable CroppedDepth is set equal to gfv_coordinate_z_max_value_minus1+1. Otherwise, CroppedDepth is set equal to 0.

When gfv_kps_pred_flag is equal to 1, the variables coordinateDeltaX[i], coordinateDelta Y[i] and coordinateDeltaZ[i] indicating the delta x-axis coordinate, delta y-axis coordinate and delta z-axis coordinate of the i-th keypoint, respectively, are derived as follows:

```
      coordinateDeltaX[ i ] = ( 1 − 2 * gfv_coordinate_dx_sign_flag[ i ] ) *
gfv_coordinate_dx_abs[ i ] ÷ ( 1 << ( gfv_coordinate_precision_factor_minus1 + 1 ) )
      coordinateDeltaY[ i ] = ( 1 − 2 * gfv_coordinate_dy_sign_flag[ i ] ) *
gfv_coordinate_dy_abs[ i ] ÷ ( 1 << ( gfv_coordinate_precision_factor_minus1 + 1 ) )
if( gfv_coordinate_z_present_flag )
  coordinateDeltaZ[ i ] = ( 1 − 2 * gfv_coordinate_dz_sign_flag[ i ] ) *
gfv_coordinate_dz_abs[ i ] ÷ (1 << (gfv_coordinate_precision_factor_minus1 + 1 ) )
      The variables coordinateX[ i ], coordinateY[ i ] and coordinateZ[ i ] indicating the
x-axis coordinate, y-axis coordinate and z-axis coordinate of the i-th keypoint, respectively, are
derived as follows:
  When gfv_kp_pred_flag is equal to 0,
      coordinateX[ i ] = ( 1 −2 * gfv_coordinate_x_sign_flag[ i ] ) *
gfv_coordinate_x_abs[ i ] ÷ ( 1 << ( gfv_coordinate_precision_factor_minus1 + 1 ) )
      coordinateY[ i ] = ( 1 − 2 * gfv_coordinate_y_sign_flag[ i ] ) *
gfv_coordinate_y_abs[ i ] ÷ ( 1 << ( gfv_coordinate_precision_factor_minus1 + 1 ) )
      if (gfv_coordinate_z_present_flag )
      coordinateZ[ i ] = ( 1 − 2 * gfv_coordinate_z_sign_flag[ i ] ) *
gfv_coordinate_z_abs[ i ] ÷ ( 1 << ( gfv_coordinate_precision_factor_minus1 + 1 ) )
  when gfv_kp_pred_flag is equal to 1,
  if( gfv_base_pic_flag ) {
    coordinateX[ i ] = (( i > 0 ) ? coordinateX[ i − 1 ] : 0 ) + coordinateDeltaX[ i ]
    coordinateY[ i ] = (( i > 0 ) ? coordinateY[ i − 1 ] : 0 ) + coordinateDeltaY[ i ]
    if (gfv_coordinate_z_present_flag )
    coordinateZ[ i ] = (( i > 0 ) ? coordinateZ[ i − 1 ] : 0 ) + coordinateDeltaZ[ i ]
  }
  else if( gfv_cnt = = 0 ) {
    coordinateX[ i ] = BaseKpCoordinateX[ i ] + coordinateDeltaX[ i ]
    coordinateY[ i ] = BaseKpCoordinateY[ i ] + coordinateDeltaY[ i ]
    if (gfv_coordinate_z_present_flag )
    coordinateZ[ i ] = BaseKpCoordinateZ[ i ] + coordinateDeltaZ[ i ]
  } else {
    coordinateX[ i ] = PrevKpCoordinateX[ i ] + coordinateDeltaX[ i ]
    coordinateY[ i ] = PrevKpCoordinateY[ i ] + coordinateDeltaY[ i ]
    if (gfv_coordinate_z_present_flag )
      coordinateZ[ i ] = PrevKpCoordinateZ[ i ] + coordinateDeltaZ[ i ]
  }
  where BaseKpCoordinateX[ i ], BaseKpCoordinateY[ i ], BaseKpCoordinateZ[ i ]
indicating the x-axis, y-axis and z-axis coordinates, respectively, of the i-th keypoint for the base
picture are derived as follows:
  if( gfv_base_pic_flag ) {
    PrevKpCoordinateX[ i ] = BaseKpCoordinateX[ i ] = coordinateX[ i ]
    PrevKpCoordinateY[ i ] = BaseKpCoordinateY[ i ] = coordinateY[ i ]
    PrevKpCoordinateZ[ i ] = BaseKpCoordinateZ[ i ] = coordinateZ[ i ]
  } else {
    PrevKpCoordinateX[ i ] = coordinateX[ i ]
    PrevKpCoordinateY[ i ] = coordinateY[ i ]
    PrevKpCoordinateZ[ i ] = coordinateZ[ i ]
  }
```

gfv_matrix_present_flag equal to 1 indicates that matrix parameters are present. gfv_matrix_present_flag equal to 0 indicates that matrix parameters are not present. When gfv_coordinate_present_flag is equal to 0, gfv_matrix_present_flag shall be equal to 1

gfv_matrix_pred_flag equal to 1 indicates that the syntax elements gfv_matrix_element_int[i][j][k][m] and gfv_matrix_element_dec[i][j][k][m] are present and the syntax element gfv_matrix_element_sign_flag[i][j][k][m] may be present. gfv_matrix_pred_flag equal to 0 indicates that the syntax elements gfv_matrix_delta_element_int[i][j][k][m] and gfv_matrix_delta_element_dec[i][j][k][m] are present and the syntax element gfv_matrix_delta_element_sign_flag[i][j][k][m] may be present. When gfv_matrix_pred_flag is not present, it is inferred to be 0.

gfv_matrix_element_precision_factor_minus1 plus 1 indicates the length, in bits, of syntax elements gfv_matrix_element_dec[i][j][k][m] and gfv_matrix_delta_element_dec[i][j][k][m].

gfv_num_matrix_types_minus1 plus 1 indicates the precision of matrix elements signalled in the SEI message. The value of gfv_matrix_element_precision_factor_minus1 shall be in the range of 0 to 31, inclusive. When gfv_matrix_present_flag is equal to 1, gfv_base_pic_flag is equal to 0, and gfv_matrix_pred_flag is equal to 1, the value of gfv_matrix_element_precision_factor_minus1 is inferred to be equal to the gfv_matrix_element_precision_factor_minus1 of the previous GFV SEI message in decoding order with the same gfv_id as the current GFV SEI message and gfv_base_pic_flag equal to 1.

gfv_matrix_type_idx[i] indicates the index of the i-th matrix type as specified in Table 3.

TABLE 3
Specification of gfv_matrix_type_idx

| Value | Specification |
|---|---|
| 0 | Affine translation matrix with the size of 2*2 or 3*3. |
| 1 | Covariance matrix with size of 2*2 or 3*3. |
| 2 | Mouth matrix representing mouth motion. |
| 3 | Eye matrix representing the open-close status and level |
| | of eyes. |
| 4 | Head rotation paramters with the size of 2*2 or 3*3 |
| | representing the head rotation in 2D space or 3D space. |
| 5 | Head translation matrix with the size of 1*2 or 1*3 |
| | representing head translationin 2D space or 3D space. |
| 6 | Head location matrix with size of 1*2 or 1*3 representing |
| | the head location in 2D space or 3D space. |
| 7 | Compact feature matrix with the size being specified by |
| | gfv_matrix_width_minus1[i] and |
| | gfv_matrix_height_minus1[i]. |
| 8 . . . 31 | Other matrix that may be used as determined by the |
| | application with the size being specified by |
| | gfv_matrix_width_minus1[i] and |
| | gfv_matrix_height_minus1[i]. |
| 32 . . . 63 | Reserved |

The undefined matrix type is used to represent the matrix type rather than affine translation matrix, covariance matrix, rotation matrix, translation matrix, and compact feature matrix. It may be used by the user to extend the matrix type

gfv_num_matrices_equal_to_num_kps_flag[i] equal to 1 indicates that the number of matrices of the i-th matrix type is equal to gfv_num_kps_minus1+1. gfv_num_matrices_equal_to_num_kps_flag[i] equal to 0 indicates the number of matrices of the i-th matrix type is not equal to gfv_num_kps_minus1+1. If gfv_matrix_present_flag is equal to 1, gfv_base_pic_flag is equal to 0, gfv_matrix_pred_flag is equal to 1, gfv_matrix_type_idx[i] is equal to 0 or 1, and gfv_coordinate_present_flag is equal to 1, the value of gfv_num_matrices_equal_to_num_kps_flag[i] is inferred to be equal to the gfv_num_matrices_equal_to_num_kps_flag[i], when present, in the previous GFV SEI message in decoding order with the same gfv_id as the current GFV SEI message and gfv_base_pic_flag equal to 1. Otherwise, when gfv_num_matrices_equal_to_num_kps_flag[i] is not present, its value is inferred to be equal to 0.

gfv_num_matrices_info[i] provides information to derive the number of the matrices of the i-th matrix type. The value of gfv_num_matrices_info[i] shall be in the range of 0 to 2¹⁰-1, inclusive. When gfv_matrix_present_flag is equal to 1, gfv_base_pic_flag is equal to 0, gfv_matrix_pred_flag is equal to 1, gfv_matrix_type_idx[i] is equal to 0 or 1, and either gfv_coordinate_present_flag is equal to 0 or gfv_num_matrix_equal_to_num_kps_flag[i] is equal to 0, the value of gfv_num_matrices_info[i] is inferred to be equal to the gfv_num_matrices_info[i], when present, in the previous GFV SEI message in decoding order with the same gfv_id as the current GFV SEI message and gfv_base_pic_flag equal to 1.

gfv_matrix_width_minus1[i] plus 1 indicates the width of the matrix of the i-th matrix type. When gfv_matrix_present_flag is equal to 1, gfv_matrix_pred_flag is equal to 0, gfv_matrix_pred_flag is equal to 1, and gfv_matrix_type_idx[i] is equal to 2 or 3 or is greater than or equal to 7, the value of gfv_matrix_width_minus1[i] is inferred to be equal to the gfv_matrix_width_minus1[i], when present, in the previous GFV SEI message in decoding order with the same gfv_id as the current GFV SEI message and gfv_base_pic_flag equal to 1.

gfv_matrix_height_minus1[i] plus 1 indicates the height of the matrix of the i-th matrix type. When gfv_matrix_present_flag is equal to 1, gfv_base_pic_flag is equal to 0, gfv_matrix_pred_flag is equal to 1, and gfv_matrix_type_idx[i] is equal to 2 or 3 or is greater than or equal to 7, the value of gfv_matrix_height_minus1[i] is inferred to be equal to the gfv_matrix_height_minus1[i], when present, in the previous GFV SEI message in decoding order with the same gfv_id as the current GFV SEI message and gfv_base_pic_flag equal to 1

gfv_matrix_for_3D_space_flag[i] equal to 1 indicates the matrix of the i-th matrix type is a matrix defined in three-dimensional space. gfv_matrix_for_3D_space_flag[i] equal to 0 indicates the matrix of the i-th matrix type is a matrix defined in two-dimensional space. When gfv_maxtrix_present_flag is equal to 1, gfv_matrix_pred_flag is equal to 0, gfv_matrix_type_idx is equal to 4, 5 or 6 and gfv_coordinate_present_flag is equal to 1, the value of gfv_maxtrix_for_3D_space_flag[i] is inferred to be equal to gfv_coordinate_z_present_flag.

When gfv_maxtrix_present_flag is equal to 1, gfv_matrix_pred_flag is equal to 0 and gfv_matrix_width_minus1[i] is not present, the value of gfv_matrix_width_minus1[i] is inferred as follows:
If gfv_matrix_type_idx[i] is equal to 0 or 1, gfv_matrix_width_minus1[i] is inferred to be equal to gfv_coordinate_z_present_flag+1
otherwise, if gfv_matrix_type_idx[i] is equal to 4, gfv_matrix_width_minus1[i] is inferred to be equal to gfv_matrix_for_3D_space_flag[i]+1
otherwise (gfv_matrix_type_idx[i] is equal to 5 or 6), gfv_matrix_width_minus1[i] is inferred to be equal to 0

When gfv_matrix_present_flag is equal to 1, gfv_matrix_pred_flag is equal to 0 and gfv_matrix_height_minus1[i] is not present, the value of gfv_matrix_height_minus1[i] is inferred as follows:
If gfv_matrix_type_idx[i] is equal to 0 or 1, gfv_matrix_height_minus1[i] is inferred to be equal to gfv_coordinate_z_present_flag+1.
otherwise (gfv_matrix_type_idx is equal to 4, 5 or 6, gfv_matrix_height_minus1[i] is inferred to be equal to gfv_matrix_for_3D_space_flag[i]+1.

The variables matrixWidth[i] and matrixHeight[i] indicating the width and height of the matrix of the i-th matrix type are derived as follows

```
    if( gfv_matrix_pred_flag ) {
  matrixWidth[ i ] = BaseMatrixWidth[ i ]
  matrixHeight[ i ] = BaseMatrixHeight[ i ]
} else {
  matrixWidth[ i ] = gfv_matrix_width_minus1[ i ] + 1
  matrixHeight[ i ] = gfv_matrix_height_minus1[ i ] +1
}
if( gfv_base_pic_flag ) {
  BaseMatrixWidth[ i ] = matrixWidth[ i ]
  BaseMatrixHeight[ i ] = matrixHeight[ i ]
}
```

gfv_num_matrices_minus1[i] plus 1 indicates the number of matrices of the i-th matrix type. The value of gfv_num_matrices_minus1[i] shall be in the range of 0 to 2¹⁰-1, inclusive. When gfv_matrix_present_flag is equal to 1, gfv_base_pic_flag is equal to 0, gfv_matrix_pred_flag is equal to 1, and gfv_matrix_type_idx[i] is greater than or equal to 7, the value of gfv_num_matrices_minus1[i] is inferred to be equal to the gfv_num_matrices_minus1[i], when present, in the previous GFV SEI message in decoding order with the same gfv_id as the current GFV SEI message and gfv_base_pic_flag equal to 1.

The variable numMatrices[i] indicating the number of the matrices of the i-th matrix type is derived as follows:

```
  if( gfv_matrix_pred_flag )
    numMatrices[ i ] = BaseNumMatrices[ i ]
  else if( gfv_matrix_type_idx[ i ] == 0 || gfv_matrix_type_idx[ i ] == 1 ) {
    if( gfv_coordinate_present_flag )
      numMatrices[ i ] = gfv_num_matrices_equal_to_num_kps_flag[ i ] ?
gfv_num_kps_minus1 + 1 : ( gfv_num_matrices_info[ i ] < gfv_num_kp_minus1 ?
gfv_num_matrices_info [ i ] + 1 : gfv_num_matrices_info [ i ] + 2 )
    else
      inumMatrices[ i ] = gfv_num_matrices_info[ i ] + 1
  }
  else if( gfv_matrix_type_idx[ i ] >=2 && gfv_matrix_type_idx[ i ] < 7)
    numMatrices[ i ] = 1
  else
    numMatrices[ i ] = gfv_num_matrices_minus1[ i ] + 1
  if( gfv_base_pic_flag )
    BaseNumMatrices[ i ] = numMatrices[ i ]
```

It is a requirement of bitstream conformance that when gfv_matrix_pred_flag is equal to 1 and gfv_base_pic_flag is equal to 0, the values of numMatrices[i], matrixWidth[i], and matrixHeight[i] for i in the range of 0 to gfv_num_matrix_types_minus1, inclusive shall be respectively equal to the values of numMatrices[i], matrixWidth[i], and matrixHeight[i] for i in the range of 0 to gfv_num_matrix_types_minus1, inclusive in each of the preceding GFV SEI message in decoding order in the current CLVS which has the same gfv_id value as the gfv_id value in the current SEI and has gfv_base_pic_flag equal to 1.

gfv_matrix_element_int[i][j][k][m] indicates the integer part of the value of the matrix element at position (m, k) of the j-th matrix of the i-th matrix type. The value of gfv_matrix_element_int[i][j][k][m] shall be in the range of 0 to 2³²-2, inclusive

gfv_matrix_element_dec[i][j][k][m] indicates the decimal part of the value of the matrix element at position (m, k) of the j-th matrix of the i-th matrix type. The length of gfv_matrix_element_dec[i][j][k][m] is gfv_matrix_element_precision_factor_minus1+1 bits.

gfv_matrix_element_sign_flag[i][j][k][m] indicates the sign of the matrix element at position (m, k) of the j-th matrix of the i-th matrix type. When gfv_matrix_element_sign_flag[i][j][k][m] is not present, it is inferred to be equal to 0.

gfv_matrix_delta_element_int[i][j][k][m] indicates the integer part of the difference value of the matrix element at position (m, k) of the j-th matrix of the i-th matrix type. The value of gfv_matrix_delta_element_int[i][j][k][m] shall be in the range of 0 to 2³²-2, inclusive.

gfv_matrix_delta_element_dec[i][j][k][m] indicates the decimal part of the difference value of the matrix element at position (m, k) of the j-th matrix of the i-th matrix type. The value of gfv_matrix_delta_element_dec[i][j][k][m] shall be in the range of 0 to 2gfv_matrix_element_precision_factor_minus1+1-1, inclusive

gfv_matrix_delta_element_sign_flag[i][j][k][m] indicates the sign of the difference value of the matrix element at position (m, k) of the j-th matrix of the i-th matrix type. When gfv_matrix_element_sign_flag[i][j][k][m] is not present, it is inferred to be equal to 0.

When gfv_matrix_pred_flag is equal to 1, the variable matrixElementDeltaVal[i][j][k][m] representing the difference value of the matrix element at position (m, k) of the j-th matrix of the i-th matrix type is derived as follows:

```
                matrixElementDelta Val[ i][ j ][ k ][ m ] = (1 − 2 *
              gfv_matrix_delta_element_sign_flag[ i ][ j ][ k ][ m ] ) *
( gfv_matrix_delta_element_int[ i ][ j ][ k ][m ] + gfv_matrix_delta_element_dec[ i ][ j ][ k ][ m ] ÷
            ( 1 << gfv_matrix_element_precision_factor_minus1 + 1 ) )
          The variable matrixElementVal[ i ][ j][ k ][ m ] representing the value of the
matrix element at position (m, k) of the j-th matrix of the i-th matrix type is derived as follows:
      when gfv_matrix_pred_flag is equal to 0
      matrixElementVal[ i][ j ][ k ][ m ] = ( 1 − 2 * gfv_matrix_element_sign_flag[ i ][ j ][ k ][ m ] ) *
( gfv_matrix_element_int[ i ][ j ][ k ][ m ] + gfv_matrix_element_dec[ i ][ j ][ k ][ m ] ÷ ( 1 <<
gfv_matrix_element_precision_factor_minus1 + 1 ) )
if( gfv_base_pic_flag )
  BaseMatrixElementVal[ i][ j ][ k ][ m ] = matrixElementVal[ i][ j ][ k ][ m ]
  Otherwise (gfv_matrix_pred_flag is equal to 1), the following applies:
      if( gfv_cnt = = 0 )
        matrixElementVal[ i][ j ][ k ][ m ] = BaseMatrixElementVal[ i][ j ][ k ][ m ] +
          matrixElementDeltaVal[ i][ j ][ k ][ m ]
      else
        matrixElementVal[ i][ j ][ k ][ m ] = PrevMatrixElementVal[ i][ j ][ k ][ m ] +
          matrixElementDeltaVal[ i][ j ][ k ][ m ]
    The following applies:
      if( gfv_base_pic_flag )
        PrevMatrixElementVal[ i][ j ][ k ][ m ] = BaseMatrixElementVal[ i][ j ][ k ][ m ] =
matrixElementVal[ i][ j ][ k ][ m ]
      else
        PrevMatrixElementVal[ i][ j ][ k ][ m ] = matrixElementVal[ i][ j ][ k ][ m ]
```

gfv_enhance_info_present_flag equal to 1 indicates the enhancement matrix is present, while gfv_enhance_info_present_flag equal to 0 indicates the enhancement matrix is not present.

gfv_matrix_element_precision_factor_minus1 plus 1 indicates the quantization factor of enhancement matrix elements. The value of gfv_matrix_element_precision_factor_minus1 shall be in the range of 0 to 31, inclusive.

gfv_num_enhance_matrices_minus1 plus 1 specifies the number of enhancement matrices signalled in the SEI message. The value of gfv_num_enhance_matrices_minus1 shall be in the range of 0 to 2¹⁰-1, inclusive.

gfv_enhance_matrix_height_minus1[i] plus 1 indicates the height of the i-th enhancement matrix. The value of gfv_enhance_matrix_height_minus1 shall be in the range of 0 to 2¹⁰-1, inclusive.

gfv_enhance_matrix_width_minus1[i] plus 1 indicates the width of the i-th enhancement matrix. The value of gfv_enhance_matrix_width_minus1 shall be in the range of 0 to 2¹⁰-1, inclusive.

gfv_enhance_matrix_element_sign_flag[i][j][k] indicates the sign of the matrix element at position (k, j) of the i-th matrix.

gfv_enhance_matrix_element[i][j][k] indicates the inv-quantized value of the element at position (k, j) of the i-th matrix. The value of gfv_enhance_matrix_element shall be in the range of 0 to 2³²-2, inclusive.

The variable matrixEnhanceElementVal[i][j][k] representing the value of the matrix element at position (k, j) of the i-th matrix is derived as follows:

```
    matrixEnhanceElementVal[ i][ j ][ k ] = (1 − 2 *
gfve_matrix_delta_element_sign_flag[ i ][ j ][ k ]) *
( gfve_matrix_delta_element[ i ][ j ][ k ] ÷
  (1 << gfve_matrix_element_precision_factor_minus1 + 1)
```

For a particular gfv_id value, the following process is used in increasing order of gfv_cnt to generate a video picture per each GFV SEI message that has gfv_base_pic_flag equal to 0 and a unique value of gfv_cnt within a picture unit:

```
  DeriveSigParam( )
  TranslatorNN (sigKeyPoint , sigMatrix)
  DeriveInputTensors( )
  if( gfv_base_pic_flag == 0 && gfv_drive_pic_fusion_flag == 0) {
    if(ChromaFormatIdc == 0 )
    GenerativeNN( InputBaseY, InputBaseKeyPoint, InputBaseMatrix,
inputDriveKeyPoint, inputDriveMatrix)
    else
    GenerativeNN( InputBaseY, InputBaseCb, InputBaseCr, InputBaseKeyPoint,
InputBaseMatrix, inputDriveKeyPoint, inputDriveMatrix)
  }
  else if(gfv_base_pic_flag == 0 && gfv_drive_pic_fusion_flag == 1) {
    if(ChromaFormatIdc == 0 )
    GenerativeNN( InputBaseY, inputDriveYputDriveY, InputBaseKeyPoint,
InputBaseMatrix, inputDriveKeyPoint, inputDriveMatrix)
    else
    GenerativeNN( InputBaseY, InputBaseCb, InputBaseCr, inputDriveY, inputDriveCb,
inputDriveCr , InputBaseKeyPoint, InputBaseMatrix,, inputDriveKeyPoint, inputDriveMatrix)
  }
  if(gfv_enhance_info_present_flag){
    if(ChromaFormatIdc == 0 )
    EnhanceNN( InputBaseY, GenY, inputEnhanceMatrix)
    else
    EnhanceNN ( InputBaseY, InputBaseCb, InputBaseCr, genY, genCb, genCr,
inputEnhanceMatrix)
  StoreOutputTensors( )
```

The process DeriveSigParam ( ) for deriving the inputs of TranslatorNN ( ) is specified as follows. Specifically, the keypoint coordinate array sigKeyPoint and the matrix sigMatrix are derived as follows:

```
if( gfv_coordinate_present_flag ) {
  for ( i = 0; i< = gfv_num_kps_minus1; i++ ) {
  sigKeyPoint[ i ][ 0 ] = coordinateX[ i ]
  sigKeyPoint[ i ][ 1 ] = coordinateY[ i ]
  if ( gfv_coordinate_z_present_flag )
    sigKeyPoint[ i ][ 2 ] = coordinateZ[ i ]
  }
}
else {
  for ( i = 0; i < =num_kps_minus1; i++ ) {
  sigKeyPoint [ i ][ 0 ] = 0
  sigKeyPoint [ i ][ 1 ] = 0
  if ( gfv_coordinate_z_present_flag )
    sigKeyPoint [ i ][ 2 ] = 0
  }
}
if( gfv_matrix_present_flag ) {
  for ( i = 0; i <= gfv_num_matrix_types_minus1; i++ ) {
  for ( j = 0; j < numMatrices[ i ]; j++ ) {
    for( k = 0; k < matrixHeight [ i ]; k++ ) {
    for ( l = 0;l < matrixWidth [ i ]; l++) {
      sigMatrix[ i ][ j ][ k ][ l ] = matrixElementVal[ i ][ j][ k][ l ]
    }
    }
  }
  }
}
else {
  for ( i = 0; i <= gfv_num_matrix_types_minus1; i++ ) {
  for ( j = 0; j < numMatrices[ i ]; j++ ) {
    for( k = 0; k < matrixHeight [ i ]; k++ ) {
    for ( 1 = 0;l < matrixWidth [ i ]; l++) {
      sigMatrix [ i ][ j ][ k ][ l ] = 0
    }
    }
  }
  }
}
```

TranslatorNN ( ) is a process to translate the various formats of the facial parameters carried in the SEI message to the fixed format of the facial parameters to be input to the generative network to generate the output picture.

Inputs to TranslatorNN ( ) are:
sigKeyPoint and sigMatrix

Outputs of TranslatorNN ( ) are:
convKeyPoint and convNumKeyPoint
convMatrix and convNumMatrix, convMatrix Width, convMatrixHeight

The process DeriveInputTensors ( ) for deriving the inputs of GenerativeNN ( ) is specified as follows:

When gfv_base_pic_flag is equal to 1, the input luma sample array CroppedYpic and chroma sample arrays CroppedCbPic and CroppedCrPic are corresponding to a base picture, and the arrays IputBase Y, InputBaseCb and InputBaseCr are derived as follows:

```
for( x = 0; x < CroppedWidth; x++ ) {
  for ( y = 0; y < CroppedHeight; y++ ) {
  InputBaseY[ x ][ y ] = InpY(CroppedYPic[ x ][ y ] )
  }
}
if (ChromaFormatIdc != 0) {
  for( x = 0; x < CroppedWidth/ SubWidthC; x++ ) {
  for ( y = 0; y < CroppedHeight/ SubHeightC; y++ ) {
    InputBaseCb[ x][ y ] = InpC(CroppedCbPic[ x][ y ] )
    InputBaseCr[ x][ y ] = InpC(CroppedCrPic[ x ][ y ] )
  }
  }
}
```

InputBase Y, InputBaseCb (when ChromaFormatIdc is not equal to 0), and InputBaseCr (when ChromaFormatIdc is not equal to 0) are also used in the semantics of next GFV SEI messages with the same value of gfv_id in output order until the next GFV SEI message with the same value of gfv_id and gfv_base_pic_flag equal to 1, exclusive, or the end of the current CLVS, whichever is earlier in output order.

When gfv_drive_pic_fusion_flag is equal to 1, the input luma sample array CroppedYPic and chroma sample arrays CroppedCbPic and CroppedCrPic are corresponding to a driving picture, and the arrays nputDriveY, inputDriveCb and input DriveCr are derived as follows:

```
for( x = 0; x< CroppedWidth; x++ ) {
  for ( y = 0; y< CroppedHeight; y++ ) {
  inputDriveY[ x ][ y ] = InpY(CroppedYPic[ x ][ y ] )
  }
}
if (ChromaFormatIdc !=0) {
  for( x = 0; x< CroppedWidth/ SubWidthC; x++ ) {
  for ( y = 0; y < CroppedHeight/ SubHeightC; y++ ) {
    inputDriveCb[ x][ y ] = InpC(CroppedCbPic[ x][ y ] )
    inputDriveCr[ x][ y ] = InpC(CroppedCrPic[ x ][ y ] )
  }
  }
}
```

When gfv_base_pic_flag is equal to 0, the keypoint coordinate array inputDriveKeyPoint and the matrix inputDriveMatrix for the current picture are derived as follows:

```
for ( i = 0; i < = convNumKeyPoint; i++ ) {
  inputDriveKeyPoint[ i ][ 0 ] = convKeyPoint[ i ][ 0 ]
  inputDriveKeyPoint [ i ][ 1 ] = convKeyPoint[ i ][ 1 ]
  inputDriveKeyPoint [ i ][ 2 ] = convKeyPoint[ i ][ 2 ]
  }
for( j = 0; j < convNumMatrix; j++ ) {
  for( k=0; k< convMatrixHeight; k++ ) {
  for ( m=0;m< convMatrixWidth; m++) {
    inputDriveMatrix[ j ][ k ][ m ] = convMatrix [ j ][ k ][ m ]
  }
  }
}
```

When gfv_base_pic_flag is equal to 1, the keypoint coordinate array InputBaseKeyPoint and the matrix InputBaseMatrix for the base picture are derived as follows:

```
    for ( i = 0; i < = convNumKeyPoint; i++ ) {
  InputBaseKeyPoint[ i ][ 0 ] = convKeyPoint[ i ][ 0 ]
  InputBaseKeyPoint [ i ][ 1 ] = convKeyPoint[ i ][ 1 ]
  InputBaseKeyPoint [ i ][ 2 ] = convKeyPoint[ i ][ 2 ]
}
for( j = 0; j < convNumMatrix; j++) {
  for( k=0; k< convMatrixHeight; k++ ) {
  for ( l=0;l< convMatrixWidth; l++) {
    InputBaseMatrix[ j ][ k ][ l ] = convMatrix [ j ][ k ][ l ]
  }
  }
}
```

When gfv_enhance_info_present_flag is equal to 1, the enhancement matrices are derived as follows:

```
if( gfv_enhance_info_present_flag ) {
  for ( i = 0; i <= gfv_num_enhance_matrices_minus1; i++ ) {
  for ( j = 0; j <= gfv_enhance_matrix_height_minus1[ i ]; j++) {
    for( k = 0; k <= gfv_enhance_matrix_width_minus1[ i ]; k++ ) {
    inputEnhanceMatrix[ i ][ j ][ k ] = matrixEnhanceElementVal[ i ][
    j][ k ]
    }
  }
  }
}
where the functions InpY( ) and InpC( ) are specified as follows:
InpY( x ) = x ÷ ( ( 1 << BitDepthY ) − 1 )
InpC( x ) = x ÷ ( ( 1 << BitDepthC ) − 1 )
```

GenerativeNN ( ) is a process to generate the sample values of an output picture corresponding to a driving picture. It is only invoked when gfc_base_pic_flag is equal to 0. Input values to GenerativeNN ( ) and output values from GenerativeNN ( ) are real numbers.

Inputs to GenerativeNN ( ) are:
When gfv_base_pic_flag is equal to 0 and gfv_drive_pic_fusion_flag is equal to 0 and ChromaFormatIdc is equal to 0: InputBaseY, InputBaseKeyPoint, InputBaseMatrix, inputDriveKeyPoint, inputDriveMatrix
When gfv_base_pic_flag is equal to 0 and gfv_drive_pic_fusion_flag is equal to 0 and ChromaFormatIdc is not equal to 1: InputBase Y, InputBaseCb, InputBaseCr, InputBaseKeyPoint, InputBaseMatrix, inputDriveKeyPoint, inputDriveMatrix
When gfv_base_pic_flag is equal to 0 and gfv_drive_pic_fusion_flag is equal to 1 and ChromaFormatIdc is equal to 0: InputBase Y, inputDriveY, InputBaseKeyPoint, InputBaseMatrix, inputDriveKeyPoint, inputDriveMatrix
When gfv_base_pic_flag is equal to 0 and gfv_drive_pic_fusion_flag is equal to 1 and ChromaFormatIdc is not equal to 1: InputBase Y, InputBaseCb, InputBaseCr, inputDriveY, inputDriveCb, inputDriveCr, InputBaseKeyPoint, InputBaseMatrix, inputDriveKeyPoint, inputDriveMatrix

Outputs of GenerativeNN ( ) are:
A luma sample array gen Y
When ChromaFormatIdc is not equal to 0, two chroma sample arrays genCb and genCr.

EnhanceNN ( ) is a process to enhance the sample values of an generated picture output by GenerativeNN ( ) It is only invoked when gfv_enhance_info_present_flag is equal to 1. Input values to EnhanceNN ( ) and output values from EnhanceNN ( ) are real numbers.

Inputs to EnhanceNN ( ) are:
When ChromaFormatIdc is equal to 0: InputBaseY, genY, inputEnhanceMatrix
When ChromaFormatIdc is not equal to 0: InputBase Y, InputBaseCb, InputBaseCr, genY, genCb, genCr, inputEnhanceMatrix

Outputs of EnhanceNN ( ) are:
A luma sample array enhance Y
When ChromaFormatIdc is not equal to 0, two chroma sample arrays enhanceCb and enhanceCr.

The process StoreOutputTensors ( ) for deriving the output is specified as follows:
when gfv_base_pic_flag is equal to 0, the output sample array out YPic[x][y], outCbPic[x][y], and outCrPic[x][y] are derived as follows:

```
  for(x=0; x< Cropped Width; x++){
    for(y=0; y< CroppedHeight; y++){
      outputYPic[ x ][ y ] = gfv_enhance_info_present_flag ? OutY(enhanceY[ x ][ y ]) :
    OutY( genY[ x ][ y ] )
    }
  }
  if(ChromaFormatIdc != 0) {
    for(x=0; x< CroppedWidth/ SubWidthC; x++){
      for(y=0; y< CroppedHeight/ SubHeightC; y++){
      outputCbPic[ x ][ y ] = gfv_enhance_info_present_flag ? OutC(enhanceCb[ x ][ y ]) :
  OutC( genCb[ x ][ y ] )
      outputCrPic[ x][ y ] = gfv_enhance_info_present_flag ? OutC(enhanceCr[ x ][ y ]) :
  OutC( genCr[ x ][ y ] )
      }
    }
  }
  when gfv_base_pic_flag is equal to 1, the output sample array outYPic[ x ][ y ],
outCbPic[ x ][ y ], and outCrPic[ x ][ y ] are derived as follows:
  for(x=0; x< CroppedWidth; x++){
    for(y=0; y< CroppedHeight; y++){
      outputYPic[ x ][ y ] = CroppedYPic [ x ][ y ]
    }
  }
  if(ChromaFormatIdc != 0) {
    for(x=0; x< CroppedWidth/ SubWidthC; x++){
      for(y=0; y< CroppedHeight/ SubHeightC; y++){
      outputCbPic[ x ][ y ] = CroppedCbPic [ x ][ y ]
      outputCrPic[ x][ y ] = CroppedCbPic [ x ][ y ]
      }
    }
  }
```

where the functions OutY ( ) and OutC ( ) are specified as follows:

OutY( x ) = Clip3( 0, ( 1 << BitDepthY ) − 1 , x * ( ( 1 << BitDepthY ) −
1 )
OutC( x ) = Clip3( 0, ( 1 << BitDepthC ) − 1 , x * ( ( 1 << BitDepthC ) −
1 )

Please note that the signaling method of the base layer key-point and matrices proposed in this embodiment can also be applied to the signaling of the enhancement layer key-point and matrices, and the signaling method of the enhancement layer matrices can also be applied to the signaling of base layer matrices.

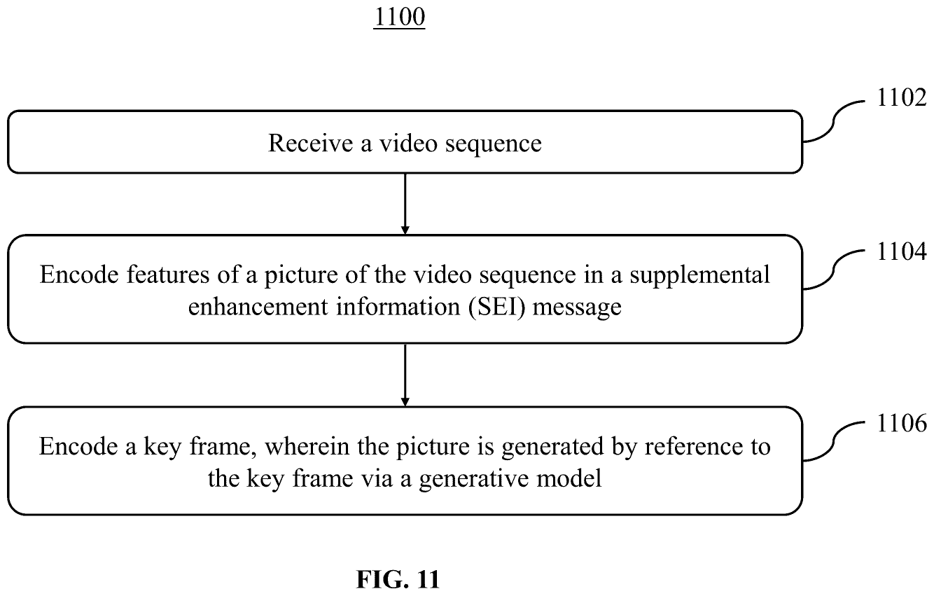

In some embodiments, a video encoding method is also provided. FIG. 11 is a flowchart of an exemplary method 1100 for encoding a video sequence, according to some embodiments of the present disclosure. As shown in FIG. 11, method 1100 may include steps 1102 and 1104, which can be implemented by an encoder (e.g., image/video encoder 124 in FIG. 1, apparatus 400 in FIG. 4, or encoder 900E shown in FIG. 9). As can be appreciated, the SEI message generated according to method 1100 can refer to the SEI message described above, and the attributes and definitions will not be elaborated on further for the sake of simplicity.

In step 1102, the encoder may receive a video sequence.

In step 1104, the encoder may encode features of a picture of the video sequence in a supplemental enhancement information (SEI) message. In some embodiments, the SEI message may include enhancement features associated with the picture, and the enhancement features can be used to enhance the picture.

In some embodiments, with further reference to FIG. 11, method 1100 may further include a step 1106, in which the encoder may encode a key frame (also called base picture), wherein the picture can be generated by reference to the key frame via a generative model. The indicator of the key frame (also called base picture) can be encoded in step 1106 and signaled in the bitstream.

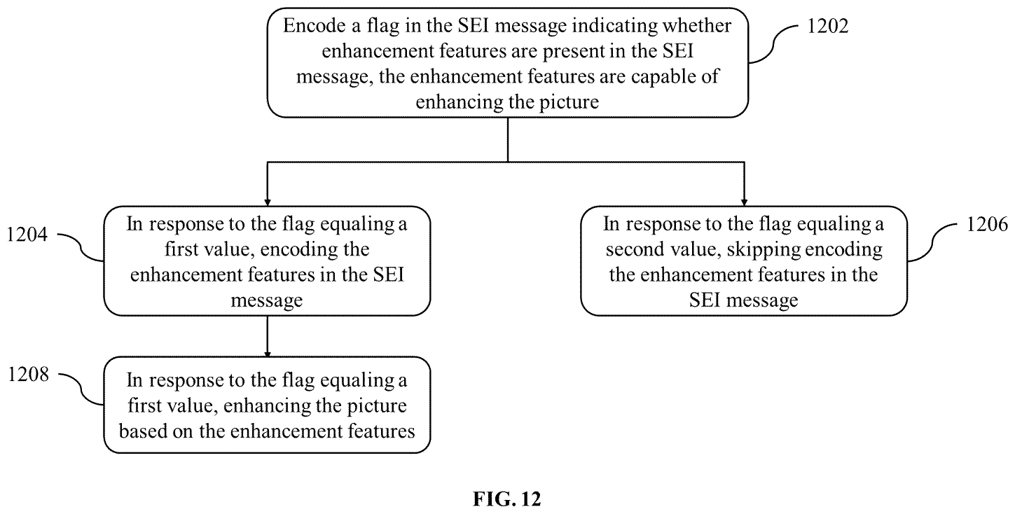

FIG. 12 is a flowchart illustrating sub-steps of exemplary video encoding method 1100 shown in FIG. 11, according to some embodiments of the present disclosure. As shown in FIG. 12, step 1104 may include sub-steps 1202 to 1206. In sub-step 1202, the encoder may encode a flag (e.g., gfv_enhance_info_present_flag shown in Table 2) in the SEI message to indicate whether enhancement features are present in the SEI message. In sub-step 1204, the encoder may encode the enhancement features in the SEI message in response to the flag equaling a first value. In sub-step 1206, the encoder may skip encoding the enhancement features in the SEI message in response to the flag equaling a second value. In some embodiments, the flag equaling the first value may indicate that the enhancement features are present, and the flag equaling the second value may indicate that the enhancement features are not present. As described above, the SEI message may include syntax elements that indicate the base features and the enhancement features.

With further reference to FIG. 12, method 1100 may further include a step 1208. The encoder may enhance the picture based on the enhancement features in response to the flag equaling a first value. In this way, the encoder may collect information for controlling the bit rate and quality of service (QOS).

In some embodiments, as described above, the enhancement features can be represented by matrices, which can be generate in sub-step 1204. The number of the matrices and the dimension of the matrices can also be signaled, followed by each element of the matrices. In some embodiments, the enhancement features can also be represented by key-points, or both by matrices and key-points. When signaling the element values of the matrices or the coordinates of the key-points, one way is to directly signal the value and the other way is to do predictive signaling. That is, the only difference between the current element and the previous element is signaled to reduce the signaling overhead.

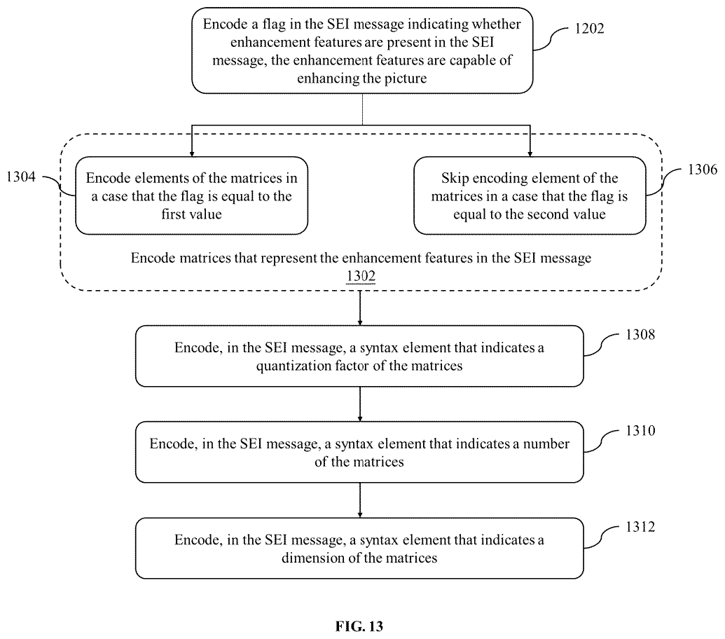

FIG. 13 is a flowchart illustrating sub-steps of exemplary video encoding method 1100 shown in FIG. 11, according to some embodiments of the present disclosure. As shown in FIG. 13, step 1104 may include sub-steps 1202 and 1302. In sub-step 1202, the encoder may encode a flag (e.g., gfv_enhance_info_present_flag shown in Table 2) in the SEI message to indicate whether enhancement features are present in the SEI message. In sub-step 1302, the encoder may encode the enhancement matrices that represent the enhancement features of the enhancement layer into matrices in the SEI message.

Furthermore, sub-step 1302 can be implemented by sub-steps 1304 and 1306. In sub-step 1304, the encoder may encode elements of the matrices in a case that the flag is equal to the first value, wherein the flag equaling the first value indicates that the enhancement features are present. In sub-step 1306, the encoder may skip encoding element of the matrices in a case that the flag is equal to the second value, wherein the flag equaling the second value indicates that the enhancement features are not present.

In some embodiments, the encoder may encode base features and enhancement features into the SEI message when the flag indicates that the enhancement features are present. Otherwise, the encoder may encode base features into the SEI message without enhancement features when the flag indicates that the enhancement features is not present.

In some embodiments, the encoder may encode a flag indicating whether an element of the matrices is present in the SEI message. In some embodiment, when the flag indicates that the element of the matrices is present, the encoder may encode the number of matrices, and the dimension of each of the number of matrices into the SEI message and encode the matrix element according to the number of the matrices and the dimension of each of the number of matrices.

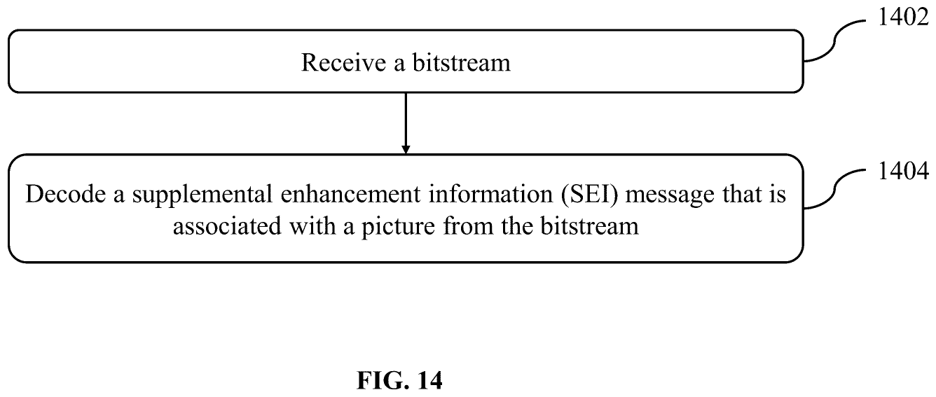

In some embodiments, a video decoding method is also provided. FIG. 14 is a flowchart of an exemplary method 1400 for decoding a bitstream, according to some embodiments of the present disclosure. As shown in FIG. 14, method 1400 may include steps 1402 and 1404, which can be performed by a decoder (e.g., image/video decoder 144 shown in FIG. 1 or decoder 900D shown in FIG. 9). As can be appreciated, the SEI message decoded according to method 1400 can refer to the SEI message described above, and the attributes and definitions will not be elaborated on further for the sake of simplicity.

In step 1402, the decoder may receive a video bitstream.

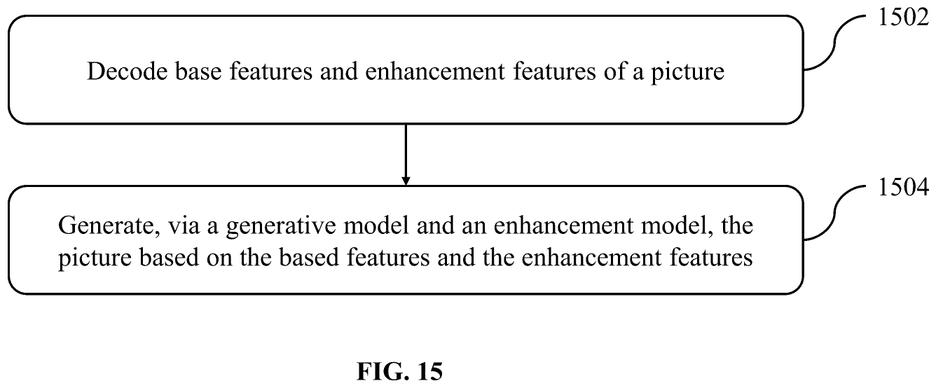

In step 1404, the decoder may decode one or more pictures of the video sequence based on the video bitstream. FIG. 15 is a flowchart illustrating sub-steps of the exemplary video decoding method 1400 shown in FIG. 14, according to some embodiments of the present disclosure. As shown in FIG. 15, step 1404 may include sub-steps 1502 and 1504. In sub-step 1502, the decoder may decode base features and enhancement features of a target picture of the one or more pictures from a supplemental enhancement information (SEI) message that is associated with the target picture. In sub-step 1504, the decoder may generate the target picture, via a generative model and an enhancement model, based on the base features and the enhancement features. As described above, the SEI message may include syntax elements that indicate the base features and the enhancement features.

In some embodiments, as described above, the enhancement features can be represented by matrices, which can be parsed in sub-step 1502. The number of the matrices and the dimension of the matrices can also be signaled in the SEI message, followed by each element of the matrices. In some embodiments, the enhancement features can also be represented by key-points, or both by matrices and key-points. When signaling the element values of the matrices or the coordinates of the key-points, one way is to directly signal the value and the other way is to do predictive signaling. That is, the only difference between the current element and the previous element is signaled to reduce the signaling overhead.

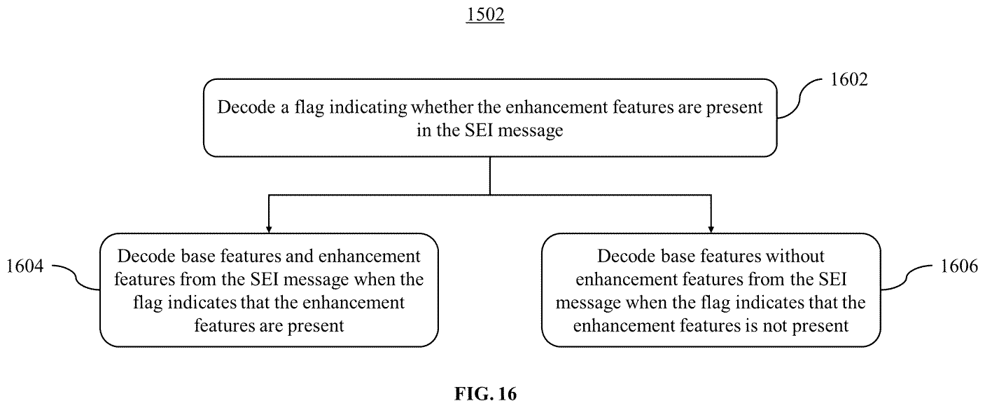

FIG. 16 is a flowchart illustrating sub-steps of exemplary video decoding method 1400 shown in FIG. 14, according to some embodiments of the present disclosure. As shown in FIG. 16, step 1502 may include sub-step 1602. In sub-step 1602, the decoder may decode a flag indicating whether the enhancement features are present in the SEI message. In addition, step 1602 may further include sub-step 1604 or sub-step 1606, which are directed to different branches. In step 1604, the decoder may decode base features and enhancement features from the SEI message when the flag indicates that the enhancement features are present. Otherwise, in step 1606, the decoder may decode base features without enhancement features from the SEI message when the flag indicates that the enhancement features is not present.

The embodiments described in the present disclosure can be freely combined.

In some embodiments, a method of generating a bitstream is also provided. In particular, the encoded pictures of the video sequence can be used to generate bitstream that can be transmitted through media (e.g., non-transitory computer-readable storage media, communication links).

In some embodiments, a non-transitory computer-readable storage medium storing a bitstream is also provided. The bitstream can be encoded and decoded according to the disclosed optical flow-based motion refinement method.

In some embodiments, a non-transitory computer-readable storage medium including instructions is also provided, and the instructions may be executed by a device (such as the disclosed encoder and decoder), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

The embodiments may further be described using the following clauses:

1. A video decoding method, including:
receiving a bitstream;
decoding a supplemental enhancement information (SEI) message that is associated with a picture from the bitstream; and
generating the picture based on the SEI message.

2. The method according to clause 1, wherein the SEI message includes enhancement features associated with the picture, and generating the picture based on the SEI message includes:
enhancing the picture based on the enhancement features.

3. The method according to clause 1, wherein decoding the SEI message includes:
decoding a flag in the SEI message indicating whether enhancement features are present, the enhancement features are capable of enhancing the picture.

4. The method according to clause 3, wherein decoding the SEI message further includes:
in response to the flag indicating the enhancement features are present, decoding the enhancement features from the SEI message; or
in response to the flag indicating the enhancement features are not present, skipping decoding the enhancement features from the SEI message.

5. The method according to clause 3, wherein enhancing the picture based on the enhancement features further includes:
in response to the flag indicating the enhancement features are present, enhancing the picture based on the enhancement features.

6. The method according to clause 3, wherein the SEI message includes matrices that represent the enhancement features.

7. The method according to clause 6, wherein decoding the SEI message further includes:
decoding elements of the matrices in response to the flag indicating the matrices are present.

8. The method according to clause 6 or 7, wherein decoding the SEI message includes:
skipping decoding elements of the matrices in response to the flag indicating the matrices are not present.

9. The method according to any of clauses 6 to 8, wherein the SEI message further includes a syntax element that indicates a quantization factor of the matrices.

10. The method according to any of clauses 6 to 9, wherein the SEI message further includes a syntax element that indicates a number of the matrices.

11. The method according to any of clauses 6 to 10, wherein the SEI message further includes a syntax element that indicates a dimension of the matrices.

12. A video encoding method, including:
receiving a video sequence; and
encoding features of a picture of the video sequence in a supplemental enhancement information (SEI) message.

13. The method according to clause 12, wherein the SEI message includes enhancement features associated with the picture, the enhancement features are capable of enhancing the picture.

14. The method according to clause 12, wherein encoding the features of the picture includes:
encoding a flag in the SEI message indicating whether enhancement features are present in the SEI message, the enhancement features are capable of enhancing the picture.

15. The method according to clause 14, wherein encoding the features of the picture further includes:
in response to the flag equaling a first value, encoding the enhancement features in the SEI message; or
in response to the flag equaling a second value, skipping encoding the enhancement features in the SEI message,
wherein the flag equaling the first value indicates that the enhancement features are present, and the flag equaling the second value indicates that the enhancement features are not present.

16. The method according to clause 14, further including:
in response to the flag equaling a first value, enhancing the picture based on the enhancement features, wherein the flag equaling the first value indicates that the enhancement features are present.

17. The method according to clause 14, wherein encoding the features of the picture further includes:
encoding matrices that represent the enhancement features in the SEI message.

18. The method according to clause 17, wherein encoding the matrices includes:
encoding elements of the matrices in a case that the flag is equal to the first value, wherein the flag equaling the first value indicates that the enhancement features are present.

19. The method according to clause 17 or 18, wherein encoding the matrices includes: skipping encoding element of the matrices in a case that the flag is equal to the second value, wherein the flag equaling the second value indicates that the enhancement features are not present.

20. The method according to any of clauses 17 to 19, wherein encoding the features of the picture further includes:
encoding, in the SEI message, a syntax element that indicates a quantization factor of the matrices.

21. The method according to any of clauses 17 to 20, wherein encoding the features of the picture further includes:
encoding, in the SEI message, a syntax element that indicates a number of the matrices.

22. The method according to any of clauses 17 to 21, wherein encoding the features of the picture further includes:
encoding, in the SEI message, a syntax element that indicates a dimension of the matrices.

23. The method according to any of clauses 12 to 22, further includes:
encoding a base picture, wherein the picture is generated by reference to the base picture via a generative model.

24. A method of generating a bitstream, comprising:
encoding a video according to any of clauses 12 to 23; and
generating a bitstream associated with the encoded video.

25. A non-transitory computer readable storage medium storing a bitstream of a video, including:
a supplemental enhancement information (SEI) message that is generated according to any of clauses 12 to 23.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in the present disclosure can be implemented by hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A video decoding method, comprising:
receiving a bitstream;
decoding a supplemental enhancement information (SEI) message that is associated with a picture from the bitstream; and
generating the picture based on the SEI message.

2. The method according to claim 1, wherein the SEI message comprises enhancement features associated with the picture, and generating the picture based on the SEI message comprises:
enhancing the picture based on the enhancement features.

3. The method according to claim 1, wherein decoding the SEI message comprises:
decoding a flag in the SEI message indicating whether enhancement features are present, the enhancement features are capable of enhancing the picture.

4. The method according to claim 3, wherein decoding the SEI message further comprises:
in response to the flag indicating the enhancement features are present, decoding the enhancement features from the SEI message; or
in response to the flag indicating the enhancement features are not present, skipping decoding the enhancement features from the SEI message.

5. The method according to claim 3, wherein enhancing the picture based on the enhancement features further comprises:
in response to the flag indicating the enhancement features are present, enhancing the picture based on the enhancement features.

6. The method according to claim 3, wherein the SEI message comprises matrices that represent the enhancement features.

7. The method according to claim 6, wherein decoding the SEI message further comprises:
decoding elements of the matrices in response to the flag indicating the matrices are present.

8. The method according to claim 6, wherein decoding the SEI message comprises:
skipping decoding elements of the matrices in response to the flag indicating the matrices are not present.

9. The method according to claim 6, wherein the SEI message further comprises a syntax element that indicates a quantization factor of the matrices.

10. The method according to claim 6, wherein the SEI message further comprises a syntax element that indicates a number of the matrices.

11. The method according to claim 6, wherein the SEI message further comprises a syntax element that indicates a dimension of the matrices.

12. A video encoding method, comprising:
receiving a video sequence; and
encoding features of a picture of the video sequence in a supplemental enhancement information (SEI) message.

13. The method according to claim 12, wherein the SEI message comprises enhancement features associated with the picture, the enhancement features are capable of enhancing the picture.

14. The method according to claim 12, wherein encoding the features of the picture comprises:
encoding a flag in the SEI message indicating whether enhancement features are present in the SEI message, the enhancement features are capable of enhancing the picture.

15. The method according to claim 14, wherein encoding the features of the picture further comprises:
in response to the flag equaling a first value, encoding the enhancement features in the SEI message; or
in response to the flag equaling a second value, skipping encoding the enhancement features in the SEI message,
wherein the flag equaling the first value indicates that the enhancement features are present, and the flag equaling the second value indicates that the enhancement features are not present.

16. The method according to claim 14, further comprising:
in response to the flag equaling a first value, enhancing the picture based on the enhancement features,
wherein the flag equaling the first value indicates that the enhancement features are present.

17. The method according to claim 14, wherein encoding the features of the picture further comprises:
encoding matrices that represent the enhancement features in the SEI message.

18. The method according to claim 17, wherein encoding the matrices comprises:
encoding elements of the matrices in a case that the flag is equal to a first value, wherein the flag equaling the first value indicates that the enhancement features are present.

19. The method according to claim 17, wherein encoding the matrices comprises:
skipping encoding element of the matrices in a case that the flag is equal to a second value, wherein the flag equaling the second value indicates that the enhancement features are not present.

20. A method of generating a bitstream, comprising:
receiving a video sequence; and
encoding features of a picture of the video sequence in a supplemental enhancement information (SEI) message; and
generating a bitstream associated with the SEI message.
